(19) United States
(12) Patent Application Publication
(10) Pub. No.: US 2010/0145624 A1
(43) Pub. Date: Jun. 10, 2010

(54) STATISTICAL VALIDATION OF CANDIDATE GENES

(75) Inventors: Venkata Krishna Kishore, Bloomington, IL (US); Daolong Wang, Normal, IL (US); Libardo Andres Gutierrez Rojas, Northfield, MN (US); Nicolas Federico Martin, Northfield, MN (US)

Correspondence Address: ALSTON & BIRD LLP;SYNGENTA, BANK OF AMERICA PLAZA, 101 SOUTH TRYON STREET, SUITE 4000, CHARLOTTE, NC, 28280-4000, US

(73) Assignee: Syngenta Participations AG, Basel (CH)

(21) Appl. No.: 12/328,689

(22) Filed: Dec. 4, 2008

(51) Int. Cl. G06F 19/00

(52) U.S. Cl. 702/19

(57) ABSTRACT

Provided herein are methods for evaluating associations between candidate markers and a trait of interest in a plant population. In various embodiments, the plant population is a breeding population, particularly early stage breeding populations. The methods include obtaining a genotypic value for candidate markers and correlating the marker with the trait. Various association models can be used to evaluate the association, and include statistical methods relevant to the structure of plant breeding populations. Population structure may be accounted for in the association models by using Principle Component Analysis. Further provided is a novel statistical approach for association mapping in early stage breeding materials using a transmission disequilibrium based methodology. Markers identified using the methods of the invention can be used in marker assisted breeding and selection, for constructing genetic linkage maps, to identify genes contributing to a trait of interest, and for generating transgenic plants having a desired trait.

### FIELD OF THE INVENTION

This invention relates to plant molecular genetics, particularly to methods for evaluating an association between a genetic marker and a phenotype in a plant population.

### BACKGROUND OF THE INVENTION

Multiple experimental paradigms have been developed to identify and analyze quantitative trait loci (QTL) (see, e.g., Jansen (1996) Trends Plant Sci 1:89). A quantitative trait locus (QTL) is a region of the genome that codes for one or more proteins and that explains a significant proportion of the variability of a given phenotype of a qualitative nature that may be controlled by multiple genes and environmental conditions. The majority of published reports on QTL mapping in crop species have been based on the use of the bi-parental cross. Typically, these paradigms involve crossing one or more parental pairs, which can be, for example, a single pair derived from two inbred strains, or multiple related or unrelated parents of different inbred strains or lines, which each exhibit different characteristics relative to the phenotypic trait of interest. Typically, this experimental protocol involves deriving 100 to 300 segregating progeny from a single cross of two divergent inbred lines (e.g., selected to maximize phenotypic and molecular marker differences between the lines). The parents and segregating progeny are genotyped for a set of evenly distributed marker loci across the genome and evaluated for one to several quantitative traits (e.g., disease resistance). QTL are then identified as significant statistical associations between genotypic values and phenotypic variability among the segregating progeny.

Numerous statistical methods for determining whether markers are genetically linked to a QTL (or to another marker) are known to those of skill in the art and include, e.g., standard linear models, such as ANOVA or regression mapping (Haley and Knott (1992) Heredity 69:315), maximum likelihood methods such as expectation-maximization algorithms, (e.g., Lander and Botstein (1989) Genetics 121:185-199; Jansen (1992) Theor. Appl. Genet., 85:252-260; Jansen (1993) Biometrics 49:227-231; Jansen (1994) In J. W. van Ooijen and J. Jansen (eds.), Biometrics in Plant breeding: applications of molecular markers, pp. 116-124, CPRO-DLO Metherlands; Jansen (1996) Genetics 142:305-311; and Jansen and Stam (1994) Genetics 136:1447-1455). Exemplary statistical methods include single point marker analysis, interval mapping (Lander and Botstein (1989) Genetics 121:185), composite interval mapping, penalized regression analysis, complex pedigree analysis, MCMC analysis, MQM analysis (Jansen (1994) Genetics 138:871), HAPLO-IM+ analysis, HAPLO-MQM analysis, and HAPLO-MQM+ analysis, Bayesian MCMC, ridge regression, identity-by-descent analysis, and Haseman-Elston regression.

Association mapping or disequilibrium mapping uses associations at the population level. Association mapping is a method for detection of gene effects based on linkage disequilibrium (LD) that is found in large existing populations (or germplasm) of diverse genetic materials. Association mapping identifies quantitative trait loci (QTLs) by examining the marker-trait associations that can be attributed to the strength of linkage disequilibrium between genetically-linked markers and functional polymorphisms across a set of diverse germplasm. Association mapping complements QTL analysis in the development of tools for molecular plant breeding. It has two main advantages over traditional linkage mapping methods. First, the fact that no pedigrees or crosses are required often makes it easier to collect data. Second, because the extent of haplotype sharing between unrelated individuals reflects the action of recombination over very large numbers of generations, association mapping has several orders of magnitude higher resolution than linkage mapping.

### SUMMARY OF THE INVENTION

Provided herein are methods for evaluating or validating associations between candidate genes and a trait of interest in a plant population. In various embodiments of the invention, the plant population comprises breeding material, particularly early stage breeding materials. The methods comprise obtaining a genotypic value for one or more markers from candidate genes and correlating the genotypic value with the trait of interest. Various association models can be used to evaluate the association, including various general linear models and mixed linear models.

The models of the present invention are developed using statistical methods that are relevant to the structure of plant breeding populations. In some embodiments, population structure is accounted for in the association models by using Principle Component Analysis. This analysis may be used alone or in conjunction with other methods of accounting for population structure in an association model. In certain aspects, the number of principle components fitted to the association model is dependent on the correlation of the principle component and the trait of interest.

Further provided herein is a novel statistical approach for association mapping in early stage breeding materials using a transmission disequilibrium based methodology. This method can be applicable to any species and is useful in discovering and validating markers linked to a phenotype of interest. This regression model (Quantitative Inbred Pedigree Disequilibrium Test 2, or “QIPDT2”) can be modified to account for location effects and/or tester effects, and provides an estimation of genetic effects and phenotypic contributions for markers in question.

Novel methods for selecting an appropriate plant population for association studies are also described herein. The method comprises evaluating genotypic and phenotypic data across multiple environmental conditions at multiple stages of development, and selecting the plant populations most relevant to the trait of interest.

Markers identified using the methods of the invention can be used in marker assisted breeding and selection, as genetic markers for constructing genetic linkage maps, to isolate genomic DNA sequence surrounding a gene-encoding or non-coding DNA sequence, to identify genes contributing to a trait of interest, and for generating transgenic plants having a desired trait.

### BRIEF DESCRIPTION OF THE FIGURES

FIG. 1 is a flowchart of an exemplary method for location selection.

FIG. 2 is a flowchart of an exemplary method for assembling a phenotypic data file for association analysis.

FIG. 3 is a flowchart of an exemplary method for assembling a genotypic data file for association analysis.

FIG. 4 is a flowchart of an exemplary method for QIPDT2 analysis.

FIG. 5 shows a comparison of cumulative distributions of p values for seven linear models for identifying associations between SNP markers and Grain Yield. The diagonal gray line shows the uniform distribution. Distributions closer to the uniform should contain less false positive associations. GLM: general linear model, MLM: mixed linear model, PC: principal component, Q: structure output for a k number of subpopulations, K: kinship matrix, psh: kinship as the proportion of shared alleles, SELECT: PCs selected according to their correlation with the trait analyzed.

FIG. 6 shows results of association p values for yield from TASSEL, QIPDT1 and QIPDT2 under full, tester-only, and location-only models. The uniform line in each plot shows the p values under null hypothesis of no associations on the genome. Assuming number of associated markers would be a very small fraction of all markers on the genome, the association p value curves should be close to the uniform line. Large deviation would indicate a higher false positive rate. As shown in the plots, TASSEL produces consistently higher false positive rate, while QIPDT1 has consistently higher negative rate, but QIPDT2 is shown to be the best among the three.

FIG. 7 represents the QIPDT test statistic.

### DETAILED DESCRIPTION OF THE INVENTION

### Overview

Estimation of the positions and effects of quantitative trait loci (QTL) is of central importance for marker assisted selection. Up to now, this has been accomplished by classical QTL mapping approaches (Lander and Botstein (1989) Genetics 121:185-199). The necessary experiments require establishment as well as pheno- and genotyping of large mapping populations and, thus, are very cost and time intensive (Parisseaux and Bemardo (2004) Theor Appl Genet 109:508-514). These limitations could be overcome by applying association mapping methods in elite germplasm, using phenotypic and genotypic data routinely collected in plant breeding programs (Jansen et al. (2003) Crop Sci 43:829-834). Moreover, results from association mapping would be of direct use in breeding, because allelic variation present in the entire elite germplasm is investigated.

Described herein is a method of discovering or validating an association between one or more candidate genes and a phenotypic trait of interest. In various embodiments, the methods comprise novel models for evaluating the association, including the QIPDT2 model for association analysis in early stage breeding materials. The methods further comprise novel means for accounting for population structure in an association analysis by using Principle Component Analysis, where the principle components that are most significantly associated with the trait of interest are used as covariates in the association model.

As used herein, the term “associated with” in connection with a relationship between a genetic marker (SNP, haplotype, insertion/deletion, tandem repeat, etc.) and a phenotype refers to a statistically significant dependence of marker frequency with respect to a quantitative scale or qualitative gradation of the phenotype. A marker “positively” correlates with a trait when it is linked to it and when presence of the marker is an indicator that the desired trait or trait form will occur in an organism comprising the marker. A marker negatively correlates with a trait when it is linked to it and when presence of the marker is an indicator that a desired trait or trait form will not occur in a plant comprising the marker. For the purposes of the present invention, the term “marker” refers to any genetic element that is being tested for an association with a trait of interest, and does not necessarily mean that the marker is positively or negatively correlated with the trait of interest.

Thus, a marker is associated with a trait of interest when the marker genotypes and trait phenotypes are found together in the progeny of an organism more often than if the marker genotypes and trait phenotypes segregated separately. The phrase “phenotypic trait” refers to the appearance or other characteristic of an organism, resulting from the interaction of its genome with the environment. The term “phenotype” refers to any visible, detectable or otherwise measurable property of an organism. The term “genotype” refers to the genetic constitution of an organism. This may be considered in total, or with respect to the alleles of a single gene, i.e. at a given genetic locus.

In some embodiments, the markers are within genes or genetic elements that are known or suspected to be directly attributable to the phenotypic trait (i.e., “candidate genes”). For example, a genetic element directly attributable to starch accumulation may be a gene directly involved in starch metabolism. Alternatively, the marker may be found within a genetic locus associated with the phenotypic trait of interest. A “locus” is a chromosomal region where a polymorphic nucleic acid, trait determinant, gene or marker is located. Thus, for example, a “gene locus” is a specific chromosome location in the genome of a species where a specific gene can be found. In various embodiments, the markers identified using the methods disclosed herein may be associated with a quantitative trait locus (QTL). The term “quantitative trait locus” or “QTL” refers to a polymorphic genetic locus with at least two alleles that differentially affect the expression of a phenotypic trait in at least one genetic background, e.g., in at least one breeding population or progeny.

In some aspects, especially useful molecular markers are those markers that are linked or closely linked to QTL markers. The phrase “closely linked,” in the present application, means that recombination between two linked loci occurs with a frequency of equal to or less than about 10% (i.e., are separated on a genetic map by not more than 10 cM). In other words, the closely linked loci co-segregate at least 90% of the time. Marker loci are especially useful in the present invention when they demonstrate a significant probability of co-segregation (linkage) with a desired trait. In some aspects, these markers can be termed linked QTL markers.

Two of the most commonly used tools for dissecting complex traits are linkage analysis and association mapping (Risch and Merikangas, Science 1996, 273:1516-1517; Mackay, Annu Rev Genet 2001, 35:303-339). Linkage analysis exploits the shared inheritance of functional polymorphisms and adjacent markers within families or pedigrees of known ancestry. Linkage analysis in plants has been typically conducted with experimental populations that are derived from a bi-parental cross. Although based on the same fundamental principles of genetic recombination as linkage analysis, association mapping examines this shared inheritance for a collection of individuals often with unobserved ancestry. As the unobserved ancestry can extend thousands of generations, the shared inheritance will only persist for adjacent loci after these many generations of recombination. Essentially, association mapping exploits historical and evolutionary recombination at the population level (Thornsberry et al. (2001) Nat Genet 28:286-289; Remington et al. (2001) Proc Natl Acad Sci USA 98:11479-11484).

Provided herein is a novel statistical approach for association mapping in early stage breeding materials using transmission disequilibrium based methodology. This method is herein referred to as the Quantitative Inbred Pedigree Disequilibrium Test 2 (QIPDT2). QIPDT2 can be applicable to any species and is useful in discovering and validating markers linked to a phenotype of interest.

In various embodiments of the present invention, the markers that are identified using the methods disclosed herein are used to select individuals (e.g., plants) and enrich the population for individuals that have desired traits. One can advantageously use molecular markers to identify desired individuals by identifying marker alleles that show a statistically significant probability of co-segregation with a desired phenotype. By identifying and selecting a marker allele (or desired alleles from multiple markers) that associates with the desired phenotype, one is able to rapidly select a desired phenotype by selecting for the proper molecular marker allele.

While the methods disclosed herein are exemplified and described using plant populations, the methods are equally applicable to animal populations, for example, humans and non-human animals, such as laboratory animals, domesticated livestock, companion animals, etc.

The methods disclosed herein incorporate a variety of statistical tests and models which may not be explicitly described herein. A thorough description of standard statistical tests can be found in basic textbooks on statistics such as, for example, Dixon, W. J. et al., Introduction to Statistical Analysis, New York, McGraw-Hill (1969) or Steel R. G. D. et al., Principles and Procedures of Statistics: with Special Reference to the Biological Sciences, New York, McGraw-Hill (1960). There are also a number of software programs for statistical analysis that are known to one skilled in the art.

### Plant Population

A majority of published reports on QTL mapping in crop species has been based on the use of the bi-parental cross (Lynch and Walsh (1997) Genetics and Analysis of Quantitative Traits, Sinauer Associates, Sunderland). Typically, this experimental protocol involves deriving 100 to 300 segregating progeny from a single cross of two divergent inbred lines (e.g., selected to maximize phenotypic and molecular marker differences between the lines). The segregating progeny are genotyped for multiple marker loci and evaluated for one to several quantitative traits in several environments. QTL are then identified as significant statistical associations between genotypic values and phenotypic variability among the segregating progeny.

The methods provided herein are useful for discovering or validating marker: trait associations in any plant population. The term “plant population” or “population of plants” indicates a group of plants, for example, from which samples are taken for evaluation, and/or from which plants are selected for breeding purposes. In preferred embodiments of the invention, the plant population relates to a breeding population of plants. A breeding population is a plant population from which members are selected and crossed to produce progeny in a breeding program. However, according to the invention, the population members from whom the markers are assessed need not be identical to the population members ultimately selected for breeding to obtain progeny plants, e.g., progeny plants used for subsequent cycles of analysis.

In some instances of the invention, a plant population may include parental plants as well as one or more progeny plants derived from the parental plants. In some instances, a plant population is derived from a single bi-parental cross, e.g., a population of progeny of a cross between two parental plants. Alternatively, a plant population includes members derived from two or more crosses involving the same or different parental plants. The population may consist of recombinant inbred lines, backcross lines, testcross lines, and the like.

In various embodiments of the invention, the plant population consists of early stage breeding materials. By “early stage” breeding material is intended that the plants are in the F2 to the F3 generation. The use of early stage breeding materials finds advantage in that the number of available breeding materials is large; the phenotypic data is available for the breeding lines; and the mapping results may directly help with selection. In the early stages of breeding, multiple lines are tested in multiple locations.

Because early breeding stages involve the evaluation of large numbers of progeny derived from multiple crosses, these breeding materials provide the necessary phenotypic data for identifying and validating markers for a wide range of agronomic traits. Thus, the present invention overcomes the need for large numbers of progeny of a single cross by using lines derived from multiple breeding crosses and phenotypic information obtained through hybrid crosses. By integrating marker analyses into existing breeding programs, the power, precision and accuracy associated with large numbers of progeny can be attained. Furthermore, the present invention allows for inferences about marker associations to be drawn across the breeding program rather than being limited to the sample of progeny from a single cross.

The term “crossed” or “cross” in the context of this invention means the fusion of gametes via pollination to produce progeny (e.g., cells, seeds or plants). The term encompasses both sexual crosses (the pollination of one plant by another) and selfing (self-pollination, e.g., when the pollen and ovule are from the same plant). The phrase “hybrid plants” refers to plants which result from a cross between genetically divergent individuals. The phrase “inbred plants” refers to plants derived from a cross between genetically related plants. The term “lines” in the context of this invention refers to a family of related plants derived by self-pollinating an inbred plant. The term “progeny” refers to the descendants of a particular plant (self pollinated) or pair of plants (cross-pollinated). The descendants can be, for example, of the F₁, the F₂ or any subsequent generation.

In various embodiments, the plant population comprises or consists of a population resulting from crosses between one or more inbred lines and one or more tester lines. The phrase “tester line” refers to a line that is unrelated to and genetically different from a set of lines to which it is crossed. Using a tester parent in a sexual cross allows one of skill to determine the association of phenotypic trait with expression of quantitative trait loci in a hybrid combination. The phrase “hybrid combination” refers to the process of crossing a single tester parent to multiple lines. The purpose of producing such crosses is to evaluate the ability of the lines to produce desirable phenotypes in hybrid progeny derived from the line by the tester cross.

The methods disclosed herein further encompass a hybrid cross between a tester line and an elite line. An “elite line” or “elite strain” is an agronomically superior line that has resulted from many cycles of breeding and selection for superior agronomic performance. In contrast, an “exotic strain” or an “exotic germplasm” is a strain or germplasm derived from a plant not belonging to an available elite plant line or strain of germplasm. Numerous elite lines are available and known to those of skill in the art of plant breeding. An “elite population” is an assortment of elite individuals or lines that can be used to represent the state of the art in terms of agronomically superior genotypes of a given crop species. Similarly, an “elite germplasm” or elite strain of germplasm is an agronomically superior germplasm, typically derived from and/or capable of giving rise to a plant with superior agronomic performance. The term “germplasm” refers to genetic material of or from an individual (e.g., a plant), a group of individuals (e.g., a plant line, variety or family), or a clone derived from a line, variety, species, or culture. The germplasm can be part of an organism or cell, or can be separate from the organism or cell. In general, germplasm provides genetic material with a specific molecular makeup that provides a physical foundation for some or all of the hereditary qualities of an organism or cell culture.

In another embodiment, the population of breeding materials consists of inbred plants grouped into pedigrees according to common parents. A “pedigree structure” defines the relationship between a descendant and each ancestor that gave rise to that descendant. A pedigree structure can span one or more generations, describing relationships between the descendant and its parents, grand parents, great-grand parents, etc.

The methods of the present invention are applicable to organisms in general and also essentially to any plant population or species. Preferred plants include agronomically and horticulturally important species including, for example, crops producing edible flowers such as cauliflower (Brassica oleracea), artichoke (Cynara scolvmus), and safflower (Carthamus, e.g. tinctorius); fruits such as apple (Malus, e.g. domesticus), banana (Musa, e.g. acuminata), berries (such as the currant, Ribes, e.g. rubrum), cherries (such as the sweet cherry, Prunus, e.g. avium), cucumber (Cucumis, e.g. sativus), grape (Vitis, e.g. vinifera), lemon (Citrus limon), melon (Cucumis melo), nuts (such as the walnut, Juglans, e.g. regia; peanut, Arachis hypoaeae), orange (Citrus, e.g. maxima), peach (Prunus, e.g. persica), pear (Pyra, e.g. communis), pepper (Solanum, e.g. capsicum), plum (Prunus, e.g. domestica), strawberry (Fragaria, e.g. moschata), tomato (Lycopersicon, e.g. esculentum); leafs, such as alfalfa (Medicago, e.g. sativa), sugar cane (Saccharum), cabbages (such as Brassica oleracea), endive (Cichoreum, e.g. endivia), leek (Allium, e.g. porrum), lettuce (Lactuca, e.g. sativa), spinach (Spinacia e.g. oleraceae), tobacco (Nicotiana, e.g. tabacum); roots, such as arrowroot (Maranta, e.g. arundinacea), beet (Beta, e.g. vulgaris), carrot (Daucus, e.g. carota), cassava (Manihot, e.g. esculenta), turnip (Brassica, e.g. rapa), radish (Raphanus, e.g. sativus) yam (Dioscorea, e.g. esculenta), sweet potato (Ipomoea batatas); seeds, such as bean (Phaseolus, e.g. vulgaris), pea (Pisum, e.g. sativum), soybean (Glycine, e.g. max), wheat (Triticum, e.g. aestivum), barley (Hordeum, e.g. vulgare), corn (Zea, e.g. mays), rice (Oryza, e.g. sativa); grasses, such as Miscanthus grass (Miscanthus, e.g., giganteus) and switchgrass (Panicum, e.g. virgatum); trees such as poplar (Populus, e.g. tremula), pine (Pinus); shrubs, such as cotton (e.g., Gossypium hirsutum); and tubers, such as kohlrabi (Brassica, e.g. oleraceae), potato (Solanum, e.g. tuberosum), and the like. The variety associated with any given population can be a transgenic variety, a non-transgenic variety, or any genetically modified variety. Alternatively, plant products of a given species naturally occurring in the wild can also be used.

### Selection of Plant Location

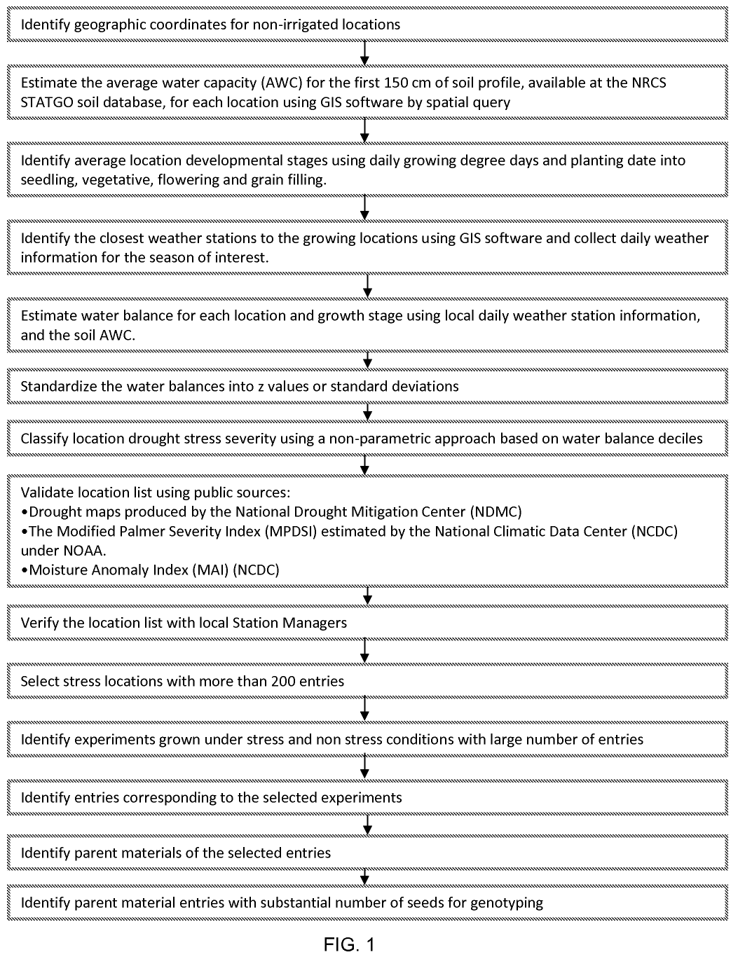

The present invention is particularly valuable for plant breeding. By way of example, while the methods of the invention are particularly useful for evaluating marker: trait associations in a plant population obtained from multiple breeding locations, it may be advantageous to select certain locations for evaluation of a particular trait of interest. Provided herein are novel methods for selection of plant locations for marker: trait association studies. The methods comprise collecting data related to the trait of interest from plants grown under a variety of different environmental conditions. The plants are then stratified into groups according to a user-defined scale associated with the conditions. For example, where temperature conditions vary across locations being tested, the plants can be stratified into ranges of temperature (e.g., group A may consist of plants grown in an area having an average daily temperature of 15-20° C., group B may consist of plants grown in an area having an average daily temperature of 21-25° C., group C may consist of plants grown in an area having an average daily temperature of 26-30° C., and so on). An exemplary flowchart of the process for location selection is depicted in FIG. 1.

In various embodiments, the data related to the trait of interest is collected at multiple developmental stages of the plant. Using corn as a non-limiting example, data may be collected at each of the seedling stage, the vegetative growth stage, the flowering stage, and the grain filling stage.

After collecting all data for location and developmental stage, each plant is assigned a score that corresponds to the environmental condition at each development stage. For example, if a plant in the above-referenced scenario was exposed to temperatures from 15-20° C. in the seedling and vegetative growth stages, temperatures from 21-25° C. in the flowering stage, and temperatures from 15-20° C. in the grain filling stage, that plant would receive a score of AABA. It will be recognized that any relevant value, range, or scale may be used to assign plants to individual groups, and that these values may be quantitative or qualitative.

For the marker: trait association, plants may be selected according to the trait that is being evaluated, and this selection may be dependent on exposure at certain stages of development. For example, if heat tolerance at seedling and vegetative growth phases is the trait of interest, plants having a score of CCAA would be selected over plants having a score of AACC. Thus, the selection of plants for the marker: trait association is based on the relative environmental conditions during specified development stages of the plant, and the selection of appropriate conditions is optimized for the trait under investigation.

A particular advantage of this type of location selection is that it eliminates or supplements the need for controlled experiments, which can be costly and sometimes difficult to achieve. Collecting data from plants growing in locations having the desired test condition essentially mimics such a controlled experiment. Data may be collected for one or more environmental conditions using a variety of tools. For example, workers at field stations at or near the planting location may be able to measure the actual environmental conditions. Alternatively, or in addition, historical data for conditions at or near the planting locations may be used. In various embodiments, data can be collected from the actual planting location, or a location that is within about 1 mile, about 2 miles, about 3 miles, about 4 miles, about 5 miles, about 10 miles, about 20 miles, about 30 miles, or more from the planting location.

In yet another embodiment, data may be obtained using Geographical Information Systems (GIS) technology. A GIS is a computer system capable of capturing, storing, analyzing, and displaying geographically referenced information; that is, data identified according to location. The power of a GIS comes from the ability to relate different information in a spatial context and to reach a conclusion about this relationship. Most of the information about the world contains a location reference, placing that information at some point on the globe. For example, when rainfall information is collected, it may be important to know where the rainfall is located. This is done by using a location reference system, such as longitude and latitude, and perhaps elevation. Many computer databases that can be directly entered into a GIS are being produced by Federal, State, tribal, and local governments, private companies, academia, and nonprofit organizations. Different kinds of data in map form can be entered into a GIS. A GIS can also convert existing digital information, which may not yet be in map form, into forms it can recognize and use. For example, digital satellite images can be analyzed to produce a map of digital information about land use and land cover. Likewise, census or hydrologic tabular data can be converted to a map like form and serve as layers of thematic information in a GIS.

Thus, information related to environmental stress conditions may be available through multiple GIS-based resources. For example, environmental stress conditions may be obtained from the National Climatic Data Center (www.ncdc.noaa.gov/oa/ncdc.html), which is available through the National Oceanic and Atmospheric Agency, and the National Drought Mitigation Center (www.drought.unl.edu/).

### Genetic Markers

Although specific DNA sequences which encode proteins are generally well-conserved across a species, other regions of DNA (typically non-coding) tend to accumulate polymorphism, and therefore, can be variable between individuals of the same species. Such regions provide the basis for numerous molecular genetic markers.

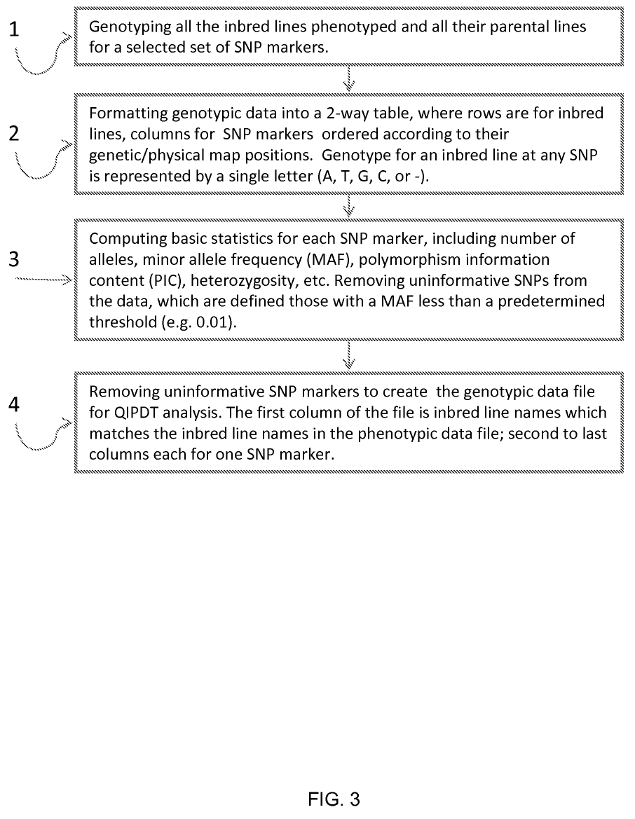

Following selection of a population of plants in the methods disclosed herein, a genotypic value for a plurality of markers is obtained for a plurality of plants in the population (see FIG. 3). The genotypic value corresponds to the quantitative or qualitative measure of the genetic marker. The term “marker” refers to an identifiable DNA sequence which is variable (polymorphic) for different individuals within a population, and facilitates the study of inheritance of a trait or a gene. A marker at the DNA sequence level is linked to a specific chromosomal location unique to an individual's genotype and inherited in a predictable manner.

The genetic marker is typically a sequence of DNA that has a specific location on a chromosome that can be measured in a laboratory. The term “genetic marker” can also be used to refer to, e.g., a cDNA and/or an mRNA encoded by a genomic sequence, as well as to that genomic sequence. To be useful, a marker needs to have two or more alleles or variants. Markers can be either direct, that is, located within the gene or locus of interest (i.e., candidate gene), or indirect, that is closely linked with the gene or locus of interest (presumably due to a location which is proximate to, but not inside the gene or locus of interest). Moreover, markers can also include sequences which either do or do not modify the amino acid sequence of a gene.

In general, any differentially inherited polymorphic trait (including nucleic acid polymorphism) that segregates among progeny is a potential marker. The term “polymorphism” refers to the presence in a population of two or more allelic variants. The term “allele” or “allelic” or “marker variant” refers to variation present at a defined position within a marker or specific marker sequence; in the case of a SNP this is the actual nucleotide which is present; for a SSR, it is the number of repeat sequences; for a peptide sequence, it is the actual amino acid present; in the case of a marker haplotype, it is the combination of two or more individual marker variants in a specific combination. An “associated allele” refers to an allele at a polymorphic locus which is associated with a particular phenotype of interest. Such allelic variants include sequence variation at a single base, for example a single nucleotide polymorphism (SNP). A polymorphism can be a single nucleotide difference present at a locus, or can be an insertion or deletion of one, a few or many consecutive nucleotides. It will be recognized that while the methods of the invention are exemplified primarily by the detection of SNPs, currently known or hereafter developed or discovered methods can similarly be used to identify other types of polymorphisms, which typically involve more than one nucleotide.

The genomic variability can be of any origin, for example, insertions, deletions, duplications, repetitive elements, point mutations, recombination events, or the presence and sequence of transposable elements. The marker may be measured directly as a DNA sequence polymorphism, such as a single nucleotide polymorphism (SNP), restriction fragment length polymorphism (RFLP) or short tandem repeat (STR), or indirectly as a DNA sequence variant, such as a single-strand conformation polymorphism (SSCP). A marker can also be a variant at the level of a DNA-derived product, such as an RNA polymorphism/abundance, a protein polymorphism or a cell metabolite polymorphism, or any other biological characteristic which has a direct relationship with the underlying DNA variant or gene product.

Two types of markers are frequently used in marker assisted breeding protocols, namely simple sequence repeat (SSR, also known as microsatellite) markers, and single nucleotide polymorphism (SNP) markers. The term SSR refers generally to any type of molecular heterogeneity that results in length variability, and most typically is a short (up to several hundred base pairs) segment of DNA that consists of multiple tandem repeats of a two or three base-pair sequence. These repeated sequences result in highly polymorphic DNA regions of variable length due to poor replication fidelity, e.g., caused by polymerase slippage. SSRs appear to be randomly dispersed through the genome and are generally flanked by conserved regions. SSR markers can also be derived from RNA sequences (in the form of a cDNA, a partial cDNA or an EST) as well as genomic material.

In one embodiment, the molecular marker is a single nucleotide polymorphism. Various techniques have been developed for the detection of SNPs, including allele specific hybridization (ASH; see, e.g., Coryell et al., (1999) Theor. Appl. Genet., 98:690-696). Additional types of molecular markers are also widely used, including but not limited to expressed sequence tags (ESTs) and SSR markers derived from EST sequences, amplified fragment length polymorphism (AFLP), randomly amplified polymorphic DNA (RAPD), and isozyme markers. A wide range of protocols are known to one of skill in the art for detecting this variability, and these protocols are frequently specific for the type of polymorphism they are designed to detect. For example, PCR amplification, single-strand conformation polymorphisms (SSCP) and self-sustained sequence replication (3SR; see Chan and Fox, Reviews in Medical Microbiology 10:185-196) may be used.

DNA for marker analysis may be collected and screened in any convenient tissue, such as cells, seed or tissues from which new plants may be grown, or plant parts, such as leafs, stems, pollen, or cells, that can be cultured into a whole plant. A sufficient number of cells are obtained to provide a sufficient amount of DNA for analysis, although only a minimal sample size will be needed where scoring is by amplification of nucleic acids. The DNA can be isolated from the cell sample by standard nucleic acid isolation techniques known to those skilled in the art.

In one embodiment, the genotypic values correspond to SNPs located within or in the vicinity of one or more candidate genes. In another embodiment, the genotypic values correspond to the values obtained for essentially all, or all of the SNPs of a high-density, whole genome SNP map. This approach has the advantage over traditional approaches in that, since it encompasses the whole genome, it identifies potential interactions of genomic products expressed from genes located anywhere on the genome, without requiring preexisting knowledge regarding a possible interaction between the genomic products. An example of a high-density, whole genome SNP map is a map of at least about 1 SNP per 10,000 kb, at least 1 SNP per 500 kb or about 10 SNPs per 500 kb, or at least about 25 SNPs or more per 500 kb. Definitions of densities of markers may change across the genome and are determined by the degree of linkage disequilibrium within a genome region.

Additionally, a number of genetic marker screening platforms are now commercially available, and can be used to obtain the genetic marker data required for the process of the present methods. In many instances, these platforms can take the form of genetic marker testing arrays (microarrays), which allow the simultaneous testing of many thousands of genetic markers. For example, these arrays can test genetic markers in numbers of greater than 1,000, greater than 1,500, greater than 2,500, greater than 5,000, greater than 10,000, greater than 15,000, greater than 20,000, greater than 25,000, greater than 30,000, greater than 35,000, greater than 40,000, greater than 45,000, greater than 50,000 or greater than 100,000, greater than 250,000, greater than 500,000, greater than 1,000,000, greater than 5,000,000, greater than 10,000,000 or greater than 15,000,000. Examples of such a commercially available product for are those marketed by Affymetrix Inc (www.affymetrix.com) or Illumina (www.illumina.com). In one embodiment, the genotypic value is obtained from at least 2 genetic markers.

It will be appreciated that, due to the nature of such information, a filtering or preprocessing of the data may be required, i.e., quality control of the data. For example, marker data may be excluded according to a particular criteria (e.g., data duplication or low frequency; see, for example Zenger et. al (2007) Anim Genet. 38(1):7-14). Examples of such filtering are described below, although other methods of filtering the data as would be appreciated by the skilled artisan may also be employed to obtain a working data set on which the marker association is determined.

In one embodiment of the invention, marker data is excluded from the analysis where the allele frequency of a particular marker is less than about 0.01, or less than about 0.05. “Allele frequency” refers to the frequency (proportion or percentage) at which an allele is present at a locus within an individual, within a line, or within a population of lines. For example, for an allele “A,” diploid individuals of genotype “AA,” “Aa,” or “aa” have allele frequencies of 1.0, 0.5, or 0.0, respectively. One can estimate the allele frequency within a line by averaging the allele frequencies of a sample of individuals from that line. Similarly, one can calculate the allele frequency within a population of lines by averaging the allele frequencies of lines that make up the population. For a population with a finite number of individuals or lines, an allele frequency can be expressed as a count of individuals or lines (or any other specified grouping) containing the allele.

In various embodiments of the invention, the set of markers evaluated for a particular trait of interest may be random markers as described above, or may be markers that have been shown or are suspected to be associated with the trait of interest in a different plant species. A large number of molecular markers for various species are known in the art and can be validated in different species using the methods disclosed herein. For example, a group of candidate genes that has been identified based on their molecular functions and/or performances in corn may be tested in soybean. Thus, the models described herein are useful for validating the effects of these candidate genes in a different plant species. When evaluating a set of candidate markers, generally random markers having no known association will also be included in the analysis.

### Trait of Interest

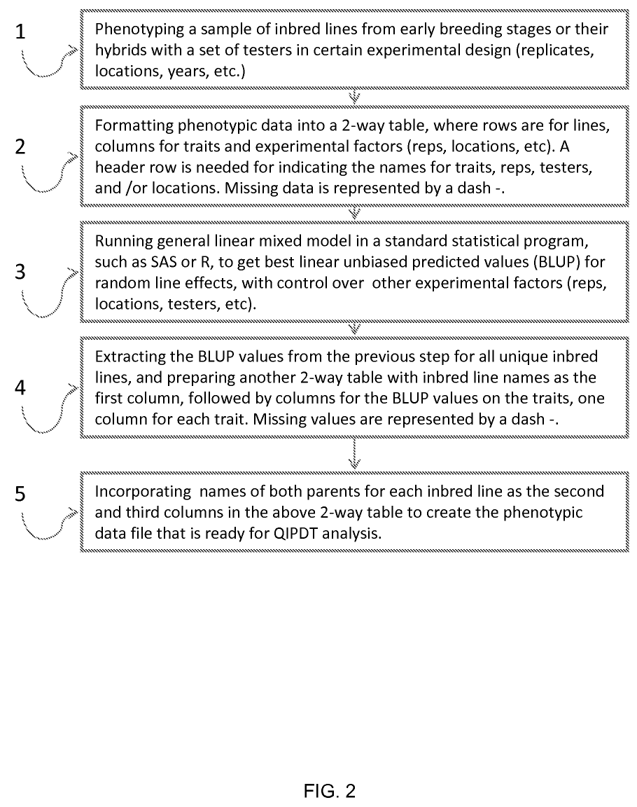

The methods of the present invention are applicable to any phenotype with an underlying genetic component, i.e., any heritable trait. A “trait” is a characteristic of an organism which manifests itself in a phenotype, and refers to a biological, performance or any other measurable characteristic(s). A trait can be any entity which can be quantified in, or from, a biological sample or organism, and it can then be used either alone or in combination with one or more other quantified entities. A “phenotype” is an outward appearance or other visible characteristic of an organism and refers to one or more trait of an organism. Thus, for each individual in the population of interest, a phenotypic value is collected for the trait of interest (see FIG. 2).

Many different traits can be inferred by the methods disclosed herein. The phenotype can be observable to the naked eye, or by any other means of evaluation known in the art, e.g., microscopy, biochemical analysis, genomic analysis, an assay for a particular disease resistance, etc. In some cases, a phenotype is directly controlled by a single gene or genetic locus, i.e., a “single gene trait.” In other cases, a phenotype is the result of several genes. A “quantitative trait loci” (QTL) is a genetic domain that is polymorphic and effects a phenotype that can be described in quantitative terms, e.g., height, weight, oil content, days to germination, disease resistance, etc, and, therefore, can be assigned a “phenotypic value” which corresponds to a quantitative value for the phenotypic trait.

For any trait, a “relatively high” characteristic indicates greater than average, and a “relatively low” characteristic indicates less than average. For example “relatively high yield” indicates more abundant plant yield than average yield for a particular plant population. Conversely, “relatively low yield” indicates less abundant yield than average yield for a particular plant population.

In the context of an exemplary plant breeding program, quantitative phenotypes include, yield (e.g., grain yield, silage yield), stress (e.g., mid-season stress, terminal stress, moisture stress, heat stress, etc.) resistance, disease resistance, insect resistance, resistance to density, kernel number, kernel size, ear size, ear number, pod number, number of seeds per pod, maturity, time to flower, heat units to flower, days to flower, root lodging resistance, stalk lodging resistance, ear height, grain moisture content, test weight, starch content, grain composition, starch composition, oil composition, protein composition, nutraceutical content, and the like.

In addition, the following phenotypic values may be correlated with the marker of interest: color, size, shape, skin thickness, pulp density, pigment content, oil deposits, protein content, enzyme activity, lipid content, sugar and starch content, chlorophyll content, minerals, salt content, pungency, aroma and flavor and such other features. For each of these indices, a distribution of parameters is determined for the sample by determining a feature (e.g., weight) associated with each item in the sample, and then measuring mean and standard deviation values from the distribution.

Similarly, the methods are equally applicable to traits which are continuously variable, such as grain yield, height, oil content, response to stress (e.g., terminal or mid-season stress) and the like, or to meristic traits that are multi-categorical, but can be analyzed as if they were continuously variable, such as days to germination, days to flowering or fruiting, and to traits with are distributed in a non-continuous (discontinuous) or discrete manner. However, it is to be understood that analogous or other unique traits may be characterized using the methods described herein, within any organism of interest.

In addition to phenotypes directly assessable by the naked eye, with or without the assistance of one or more manual or automated devices, included, e.g., microscopes, scales, rulers, calipers, etc., many phenotypes can be assessed using biochemical and/or molecular means. For example, oil content, starch content, protein content, nutraceutical content, as well as their constituent components can be assessed, optionally following one or more separation or purification step, using one or more chemical or biochemical assay. Molecular phenotypes, such as metabolite profiles or expression profiles, either at the protein or RNA level, are also amenable to evaluation according to the methods of the present invention. For example, metabolite profiles, whether small molecule metabolites or large bio-molecules produced by a metabolic pathway, supply valuable information regarding phenotypes of agronomic interest. Such metabolite profiles can be evaluated as direct or indirect measures of a phenotype of interest. Similarly, expression profiles can serve as indirect measures of a phenotype, or can themselves serve directly as the phenotype subject to analysis for purposes of marker correlation. Expression profiles are frequently evaluated at the level of RNA expression products, e.g., in an array format, but may also be evaluated at the protein level using antibodies or other binding proteins.

In addition, in some circumstances it is desirable to employ a mathematical relationship between phenotypic attributes rather than correlating marker information independently with multiple phenotypes of interest. For example, the ultimate goal of a breeding program may be to obtain crop plants which produce high yield under low water, i.e., drought, conditions. Rather than independently correlating marker for yield and resistance to low water conditions, a mathematical indicator of the yield and stability of yield over water conditions can be correlated with markers. Such a mathematical indicator can take on forms including; a statistically derived index value based on weighted contributions of values from a number of individual traits, or a variable that is a component of a crop growth and development model or an ecophysiological model (referred to collectively as crop growth models) of plant trait responses across multiple environmental conditions. These crop growth models are known in the art and have been used to study the effects of genetic variation for plant traits and map QTL for plant trait responses. See references by Hammer et al. 2002. European Journal of Agronomy 18: 15-31, Chapman et al. 2003. Agronomy Journal 95: 99-113, and Reymond et al. 2003. Plant Physiology 131: 664-675.

### Association Analysis

Population Structure

The methods disclosed herein are useful for discovering or validating the association between a genetic marker and a phenotypic trait of interest in a population of plants. The methods comprise applying one or more statistical models to detect or validate the association, particularly in a breeding population. The methods comprise novel models for evaluating this association (e.g., QIPDT2), as well as improvements to existing methods for accounting for population structure in an association analysis (e.g., by using significantly-associated principle components as covariates in the association model). These methods are useful for improving the accuracy and efficiency of marker identification and validation, in part by decreasing the number of false positive results.

A potentially serious obstacle to association mapping is confounding by population structure. The comparatively high resolution provided by association mapping is dependent upon the structure of linkage disequilibrium (LD) across the genome. Linkage disequilibrium (LD) refers to the non-random association of alleles between genetic loci. Many genetic and non-genetic factors, including recombination, drift, selection, mating pattern, and admixture (i.e. a population of subgroups with different allele frequencies), affect the structure of LD (Flint-Garcia et al., Annu Rev Plant Biol 2003, 54:357-374; Gaut and Long, Plant Cell 2003, 15:1502-1506). The key to association mapping is the LD between functional loci and markers that are physically linked. It is well known that population structure may cause spurious correlations, leading to an elevated false-positive rate (Lander and Schork (1994) Science 265: 2037-2048.).

The concern about population structure is that LD can be caused by admixture of subpopulation, which leads to false-positive results (i.e., type I errors) if not correctly controlled in statistical analysis. Such false-positives arise when testing random genetic markers with different frequencies in subpopulations for a trait with parallel phenotypic differences. The complex evolutionary and breeding history in maize (Liu et al. Genetics 2003, 165:2117-2128; Flint-Garcia et al. Plant J 2005, 44:1054-1064) and other species (Nordborg et al. PLoS Biol 2005, 3:e196; Garris et al. Genetics 2005, 169:1631-1638) has undoubtedly created both population structure and complex familial relationships. To reduce this risk, estimates of population structure must be included in association analysis. Different statistical approaches have been designed to deal with the population structure issue for different association samples (Yu et al. Nat Genet 2006, 38:203-208).

In one embodiment of the invention, the methods disclosed herein comprise means for reducing confounding due to population structure by first assigning individuals to subpopulations using a model-based Bayesian clustering algorithm, STRUCTURE, and then carrying out all analyses conditional on the inferred assignments. See, for example, Pritchard et al. (2000) Am J Hum Genet 67: 170-181, which is herein incorporated by reference in its entirety.

In another embodiment of the invention, population structure is addressed using genomic control (GC) and structured association (SA) methods. With GC, a set of random markers is used to estimate the degree of inflation of the test statistics generated by population structure, assuming such structure has a similar effect on all loci (Devlin and Roeder, Biometrics 1999, 55:997-1004). By contrast, SA analysis first uses a set of random markers to estimate population structure (Q), and then incorporates this estimate into further statistical analysis (Pritchard and Rosenberg, Am J Hum Genet 1999, 65:220-228; Pritchard et al. Genetics 2000, 155:945-959; Falush et al. Genetics 2003, 164:1567-1587). Modification of SA with logistic regression is also encompassed herein (Thomsberry et al. Nat Genet 2001, 28:286-289; Wilson et al. Plant Cell 2004, 16:2719-2733). A general linear model version of this approach is available in TASSEL (www.maizegenetics.net).

A unified mixed-model approach for association mapping that accounts for multiple levels of relatedness has recently been previously developed (Yu et al. Nat Genet 2006, 38:203-208) and can be used in the methods disclosed herein. In this method, random markers are used to estimate Q and a relative kinship matrix (K), which are then fit into a mixed-model framework to test for marker-trait association. In the present invention, kinship coefficients are calculated as the proportion of shared alleles for each pair of individuals (Kp shared) rather than the proportion of shared haplotypes as described in Zhao et al. (2007). The matrix of K coefficients may be included in some association models to assess the control for spurious associations due to close interrelatedness of the lines in the population. The estimated log probability of data Pr(X|K) for each value of k can be plotted to choose an appropriate number of subpopulations to include in the covariance matrix. The number of subpopulations to be used in the association model can be determined empirically, or can be calculated using methods known in the art. For example, several authors have reported on the ability of STRUCTURE to detect the real number of sub-populations (k) which composes a data set and the ways to get this k value (Evanno et al., 2005; Camus-Kulandaivelu et al., 2007). Evanno et al. (2005) proposed that Δk (an ad hoc quantity related to the second order rate of change of the log probability of data) is a good predictor of the real number of clusters in the data set.

A widely-used method of dimension reduction is Principal Component Analysis (PCA), which finds linear combinations of the data such that the variance is maximized. Principal component analysis (PCA) is a statistical protocol for extracting the main relations in data of high dimensionality and reduces the datasets to lower dimensions for analysis. Often its operation can be thought of as revealing the internal structure of the data in a way which best explains the variance in the data. Application of this new method to maize quantitative traits and human gene expression data resulted in improved control of both type I and type II error rates when compared with other methods.

PCA is mathematically defined as an orthogonal linear transformation that transforms data to a new coordinate system such that the greatest variance by any projection of the data comes to lie on the first coordinate (called the first principal component), the second greatest variance on the second coordinate, and so on. PCA is theoretically the optimum transform for a given data in least square terms. PCA can be used for dimensionality reduction in a data set by retaining those characteristics of the data set that contribute most to its variance, by keeping lower-order principal components and ignoring higher-order ones. See, for example, Ralael and Woods Digital image processing. Addison Wessley Publishing Company, 1992. The term “low dimensional space” refers to, for a database of information with many variables or unknowns, a subset of the information database with a reduced number of variables or unknowns. However, the low dimensional space retains substantially all the information or substantially all the relationships between the information in the information database. PCA takes complex correlated data arranged in multidimensional space and reduces the high dimensionality of the data into more simple, linearized axes while retaining as much of the original variation as possible. All correlated components of sample data will form a correlation matrix, where the variances of the transformed, standardized data along an axis (eigenvectors) are the principal components. Such axes correspond to the largest eigenvalues in the direction of the largest variation of the data.

The PCs can be obtained using the SMARTPCA software package or software with similar capabilities. The selection by linear modeling can be implemented in most statistical software available (e.g. SAS, JMP, R, S-Plus, etc.). Other appropriate statistical packages are available from a variety of public and commercial sources, and are known to those of skill in the art.

Classically, methods utilizing the Eigenvalues corresponding to the rows of the rotation matrix have been used in order to choose the number of principal components to use as covariates in an association model. This includes methods such as keeping principal components with eigenvalue greater than unity, Scree plot, Horn's procedure, regression methods, Bartlett's test and the broken-stick test (see, for example Johnson and Wichern. 1988. Applied Multivariate Analysis. 2d ed., Englewood Cliffs, N.J.: Prentice-Hall; and, Sharma, Applied Multivariate Techniques, Wiley, 1996). Thus, in one embodiment of the invention, PCs are ranked according to the proportion of variance accounted for by each PC, and the top 1, 2, 3, 4, 5, 6, 7, 8, 9, 10, or more PCs are used in the association model.

Alternatively, in another embodiment of the invention, a statistical correlation is computed between each PC and the phenotypic trait of interest. The PCs are ordered according to their correlation with the phenotypic trait, so that the first PC fitted in the association model is the most highly correlated with the phenotypic trait. In various embodiments, all PCs having a p-value for the phenotypic trait in the 5th percentile are included in the association model. In another embodiment, all PCs having a p-value in the 1st, 2nd, 3rd, 4th, 5th, 6th, 7th, 8th, 9th, or 10th percentile are fitted into the association model. Thus, in the present invention, the use of Principal Component (PC) analysis or Eigen analysis of molecular marker data in models for association mapping proposed by Patterson et al. (2006; PLos Genetics 2:2074-2093) is enhanced by a trait of interest-specific selection of PCs contributing significantly to the observed variation of the trait of interest. This method is a novel method to determine the number of principal components to be used in an association model, which is distinct from the PC selection methods described supra.

In either method of selection of the appropriate number of PCs, multiple PCs may be added to the model simultaneously, or forward stepwise regression may be used to build the model. Under forward stepwise regression, the k^{th} PC added is the PC which adds the most information, given that the previous (k-1) PCs have already been fitted.

Association Models

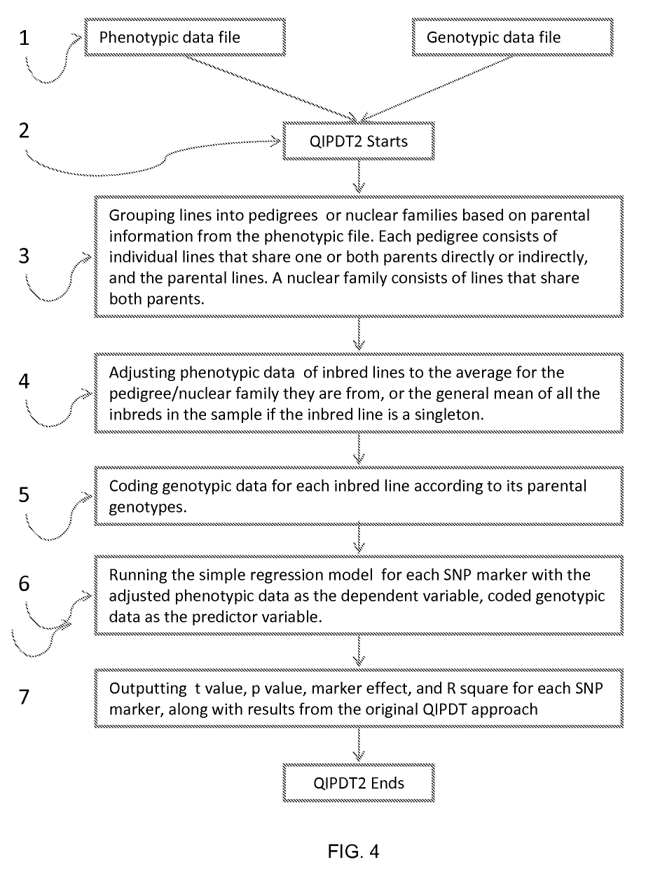

Disclosed herein are methods for discovering or validating a statistical correlation between a marker and a trait of interest. The correlation can be established using the novel QIPDT2 method disclosed infra, or may be established using other statistical methods disclosed herein (or generally known in the art) for the purpose of evaluating the strength of an association between the marker and the phenotype, e.g., determining the magnitude of the contribution of the gene to phenotypic expression and/or determining the proximity of linkage between the marker and the gene influencing the phenotype of interest. As used herein, the term “linkage” is used to describe the degree with which one marker locus is “associated with” a trait of interest. An exemplary method for performing an association analysis is depicted in the flowchart of FIG. 4.

A marker locus can be associated with (linked to) a trait, e.g., a marker locus can be associated with a trait of interest when the marker locus is in linkage disequilibrium with the trait. The degree of linkage of a molecular marker to a phenotypic trait is measured, e.g., as a statistical probability of co-segregation of that molecular marker with the phenotype. Association mapping (often referred as linkage disequilibrium mapping) has become a powerful tool to unveil the genetic control of complex traits. Association mapping relies on the large number of generations, and therefore recombination opportunities, in the history of a species, that allow the removal of association between a QTL and any marker not tightly linked to it (Jannink and Walsh, 2001).

In various embodiments of the invention, a fixed effect model can be used to evaluate a marker: trait association. In the fixed effects model, members of one family or full siblings are used to determine the association between genetic markers and a phenotypic trait. As used herein the term “fixed effects” preferably refers seasonal, spatial, geographic, environmental or managerial influences that cause a systematic effect on the phenotype or to those effects with levels that were deliberately arranged by the experimenter, or the effect of a gene or marker that is consistent across the population being evaluated.

Soller & Genizi first proposed fixed effects models for identifying QTL using full-sibling and half-sibling population structures (Soller & Genizi, Biometrics 34:47 (1978)). Inferences about QTL effects and genomic sites derived from the association between the phenotypic trait and the genetic marker using this model are specific to the sample of lines and progeny used for the evaluation. These inferences cannot be extended to other families or progeny because the fixed effect model does not view the genotypic and phenotypic data as a representative sample from a larger population.

Because members of individual families are often genetically related and represent only a sample of all possible crosses within a breeding population, a model which would be applicable to the larger breeding population is needed. Thus, the marker: trait association can be evaluated in a population of related individuals using a random effects model.

A random effects model differs from the fixed effects model in that there are no estimated marker effects. Rather, an estimate is made of the proportion of the phenotypic variability, which can be ascribed to the variability in the markers. Unlike the fixed effects model, it is possible to predict genotypic effects for sampled markers at the QTL in untested progeny. Also, unlike the fixed effects model, predicted phenotypes can be extended to other related families in the breeding population. Random effects models have been prepared for full-sibling and half-sibling family structures in human pedigrees (Goldgar, Am. J. Hum. Genet. 47:957 (1990)) and to general outbred populations (Xu & Atchley, Genetics 141:1198 (1995)).

However, random effects models do not allow for tester effects. Because testers are specifically selected, their effects on the phenotype of the progeny are fixed. Therefore, in some embodiments of the present invention, the resulting model consists of mixed random and fixed effects. As used herein the term “mixed model equation” refers to a model for equations that solve for both random effects and fixed effects. The term random effect is used to denote factors that have an unsystematic impact on the trait with levels that may represent a random distribution. Random effects will typically have levels that were sampled from a population of possible samples. Linear models incorporating both fixed effects and random effects are called mixed linear models. Mixed linear models are known in the art and are useful in the association analyses described herein.

As used herein, the output of the association models (which describes the linkage relationship between a molecular marker and a phenotype) is given as a “probability” or “adjusted probability.” The probability value is the statistical likelihood that the particular combination of a phenotype and the presence or absence of a particular marker allele is random. Thus, the lower the probability score, the greater the likelihood that a phenotype and a particular marker will co-segregate. In some aspects, the probability score is considered “significant” or “nonsignificant.” In some embodiments, a probability score of 0.05 (p=0.05, or a 5% probability) of random assortment is considered a significant indication of co-segregation. However, the present invention is not limited to this particular standard, and an acceptable probability can be any probability of less than 50% (p=0.5). For example, a significant probability can be less than 0.25, less than 0.20, less than 0.15, or less than 0.1.

Exemplary association models include the following:

TASSEL Model

In various embodiments, the java-based software TASSEL (Trait Analysis by aSSociation, Evolution and Linkage) can be used to determine marker: trait associations. See, Yu et al. (2005) Nature Genetics 38:203-208, herein incorporated by reference. TASSEL makes use of advanced statistical methods to maximize statistical power for finding QTLs. The method uses both a structured association approach (Pritchard et al (2000) Am J Human Genet 67:170-181; Thornsberry et al. (2001) Nature Genetics 28:286-289) and a unified mixed model approach to minimize the risk of false positives by integrating population structure and family relatedness within populations.

TASSEL allows for linkage disequilibrium statistics to be calculated and visualized graphically. Linkage disequilibrium is estimated by the standardized disequilibrium coefficient, D′, as well as r² and P-values. Diversity analysis tools are also available, where diversity estimates include average pair-wise divergence (π) and segregating sites. Other features of TASSEL include a sequence alignment viewer, extraction of SNPs and indels (insertions & deletions) from alignments, a neighbor-joining cladogram, and a variety of data graphing functions. TASSEL is capable of merging data from different sources into a single analysis dataset, impute missing data using a k-nearest-neighbor algorithm (Cover and Hart (1967) Proc IEEE Trans Inform Theory 13), and conduct principal components analysis (PCA) to reduce a set of correlated phenotypes.

Open source code for the TASSEL software package is available at: sourceforge.net/projects/tassel. The package uses the standard PAL library (iubio.bio.indiana.edu/soft/molbio/java/pal/doc/), the COLT library (dsd.lbl.gov/˜hoschek/colt/), and jFreeChart (wwwjfree.org/jfreechart/). Database access is achieved by GDPC middleware (www.maizegenetics.net/gdpc). A user manual for TASSEL can be found at the website: maizegenetics.net/tassel.

TASSEL is designed for use with unrelated samples and is capable of controlling moderate to weak population structure. Population structure (Q) and/or Kinship (K) estimates can be incorporated in the models to reduce the number of false positives. It is also possible to replace the Q (Structure) matrix by a PCA matrix (Eigenvalues) (Price et al., 2006; Zhao et al., 2007). The model used in TASSEL may be a general or a mixed liner model that incorporates PCA, or may be a general or a mixed linear model that incorporates PCA and kinship analysis. The general linear model (GLM) procedure in TASSEL includes the option to perform permutations to find out the experiment-wise error rate that corrects for accumulation of false positives when doing multiple comparisons. The mixed linear model (MLM) procedure does not include correction for multiple testing. In this model, the Bonferroni correction can be used to avoid accumulation of false positive.

QIPDT

It is difficult to detect pedigree hierarchy with TASSEL and TASSEL is not optimized for early stage breeding materials. Thus, in some embodiments of the invention, the Quantitative Inbred Pedigree Disequilibrium Test (QIPDT) is used. QIPDT is a test for family based association mapping with inbred lines from plant breeding programs. See Stich et al. (2006) Theor Appl Genet 113:1121-1130; herein incorporated by reference. QIPDT is a QTL detection method for data collected routinely in plant breeding programs. QIPDT is a family-based association test applicable to genotypic information of parental inbred lines and geno- and phenotypic information of their offspring inbreds. The QIPDT extends the QPDT, a family-based association test. Nuclear families consisting of two parental inbred lines and at least one offspring inbred line can be combined to extended pedigrees, the basis of the QIPDT, if the parental lines of different nuclear families are related. QIPDT also takes into account the correction of Martinet al. (2001) Am J Hum Genet 68:1065-1067 regarding the pedigree disequilibrium test.

One major advantage of QIPDT is that this method can be applied to materials from early breeding stages (e.g. stage 2 and 3), and thus is cost-efficient, because phenotypic data on these materials have been collected for breeding purpose. QIPDT is a test statistic, T, which is calculated as described in Stich et al. 2006. For each marker, a T value is calculated, and its p value is found from standard normal distribution.

OIPDT2

While QIPDT is useful for testing the statistical significance of association, it does not provide an estimate of the magnitude of the marker effect, nor the relative genetic contribution to the total phenotypic variance. Thus, the present invention provides an improved approach using a regression model, which is referred to herein as QIPDT2. QIPDT2 is a novel method that adopts the same methods for marker coding and phenotypic adjustment as used in QIPDT1, with two improvements: 1) a regression model is fitted for the marker and phenotypic data, which allows estimation of genetic effects and phenotypic contributions for markers in question; 2) extending the approach to hybrids of inbreds with different testers grown at multiple locations, while the original QIPDT approach is applicable for inbreds only. Such extension is achieved by extracting genetic values of inbreds from a mixed model that accounts for tester effects and non-genetic effects (e.g. locations).

The model for QIPDT2 can be written as:

yᵢₖ=β₀+β₁xᵢₖ+eⱼₖ

where yₖᵢ is adjusted phenotypic value for individual i in pedigree k; xₖᵢ is coded marker genotypic value; β₀ is the intercept; β₁ is the regression coefficient, or genetic effect, of the genetic marker in question. The methods for adjusting phenotypic values and coding marker genotypes are the same as used by Stich et al. (2006)—for bi-allelic SNP markers, it takes −1 for one of the alleles and 1 for the other, given the two parents have a different genotype, or 0 if the two parents have the same genotype or the genotype data is missing for any of them. With this model of the invention, an estimate of both the genetic effect and R² for each marker can be obtained. The determinant coefficient of the model (R²) provides an estimate of the phenotypic contribution of the marker. In some embodiments, the phenotypic data are pre-adjusted to exclude effects from testers and/or locations before being further adjusted for pedigree structure. The methods for pre-adjustment are disclosed elsewhere herein.

When phenotypic data is collected on hybrids of the inbreds with a set of testers, mixed models are fitted to extract the genetic effects of the inbreds. If experiments were conducted at different locations, a location effect is added in the model. This will lead to the following full model:

yᵢⱼₖ=μ+θᵢ+τⱼ+δₖ+eᵢⱼₖ,

where yᵢⱼₖ is the original phenotypic observation on hybrid between inbred i and tester j at location k (assuming 1 replication at each location—one more effect would be added if replications were implemented). Tester effect (τⱼ)) is treated as fixed effect; inbred (θᵢ) and location effects (δₖ) are treated as random, in the mixed model. BLUP is used to predict genetic values (θᵢ) of all inbreds, which are to be used for calculating deviations from pedigree means as described supra.

### Phenotypic Adjustment

In various embodiments of the present invention, plant populations in which marker: trait associations are evaluated include populations of hybrids resulting from a cross between inbred lines and tester lines. However, many statistical approaches (TASSEL and QIPDT) were designed for data on inbred lines, which require a unique trait value for each line. To obtain a unique trait value for each inbred line that could be compared against its genotype, it is necessary to make phenotypic adjustments that help to control the effect of tester and/or location. Phenotypic adjustments can also be performed on data obtained from plants grown in different geographic locations.

When adjusting for both tester effects and location effects, the “full model” for phenotypic adjustment is:

Phenotype=Location effect (random)+Line effect (random)+Tester effect (fixed)+error term

The “by Location” model can be used for adjusting for location as follows:

Phenotype=Line effect (random)+Tester effect (fixed)+error term

The “by Tester” model can be used for lines crossed to a particular tester as follows:

Phenotype=Location effect (random)+Line effect (random)+error term

### Computer-Implemented Methods

The methods described above for evaluating a marker: trait association may be performed, wholly or in part, with the use of a computer program or computer-implemented method.

Computer programs and computer program products of the present invention comprise a computer usable medium having control logic stored therein for causing a computer to execute the algorithms disclosed herein. Computer systems of the present invention comprise a processor, operative to determine, accept, check, and display data, a memory for storing data coupled to said processor, a display device coupled to said processor for displaying data, an input device coupled to said processor for entering external data; and a computer-readable script with at least two modes of operation executable by said processor. A computer-readable script may be a computer program or control logic of a computer program product of an embodiment of the present invention.

It is not critical to the invention that the computer program be written in any particular computer language or to operate on any particular type of computer system or operating system. The computer program may be written, for example, in C++, Java, Perl, Python, Ruby, Pascal, or Basic programming language. It is understood that one may create such a program in one of many different programming languages. In one aspect of this invention, this program is written to operate on a computer utilizing a Linux operating system. In another aspect of this invention, the program is written to operate on a computer utilizing a MS Windows or MacOS operating system.

It would be understood by one of skill in the art that codes may be performed in any order, or simultaneously, in accordance with the present invention so long as the order follows a logical flow.

### Downstream Use of Markers

The markers identified using the methods disclosed herein may be used for genome-based diagnostic and selection techniques; for tracing progeny of an organism; to determine hybridity of an organism; to identify variation of linked phenotypic traits, mRNA expression traits, or both phenotypic and mRNA expression traits; as genetic markers for constructing genetic linkage maps; to identify individual progeny from a cross wherein the progeny have a desired genetic contribution from a parental donor, recipient parent, or both parental donor and recipient parent; to isolate genomic DNA sequence surrounding a gene-coding or non-coding DNA sequence, for example, but not limited to a promoter or a regulatory sequence; in marker-assisted selection, map-based cloning, hybrid certification, fingerprinting, genotyping and allele specific marker; and as a marker in an organism of interest.

The primary motivation for developing molecular marker technologies from the point of view of plant breeders has been the possibility to increase breeding efficiency through marker assisted breeding. After positive markers have been identified through the statistical models described above, the corresponding genetic marker alleles can be used to identify plants that contain the desired genotype at multiple loci and would be expected to transfer the desired genotype along with the desired phenotype to its progeny. A molecular marker allele that demonstrates linkage disequilibrium with a desired phenotypic trait (e.g., a quantitative trait locus, or QTL) provides a useful tool for the selection of a desired trait in a plant population (i.e., marker assisted breeding).

A “marker locus” is a locus that can be used to track the presence of a second linked locus, e.g., a linked locus that encodes or contributes to expression of a phenotypic trait. For example, a marker locus can be used to monitor segregation of alleles at a locus, such as a QTL, that are genetically or physically linked to the marker locus. Thus, a “marker allele,” alternatively an “allele of a marker locus” is one of a plurality of polymorphic nucleotide sequences found at a marker locus in a population that is polymorphic for the marker locus. In some aspects, the present invention provides methods for identifying or validating marker loci correlating with a phenotypic trait of interest. Each of the identified markers is expected to be in close physical and genetic proximity (resulting in physical and/or genetic linkage) to a genetic element, e.g., a QTL that contributes to the trait of interest.

The presence and/or absence of a particular genetic marker allele in the genome of a plant exhibiting a preferred phenotypic trait is determined by any method listed above, e.g., RFLP, AFLP, SSR, amplification of variable sequences, and ASH. If the nucleic acids from the plant hybridizes to a probe specific for a desired genetic marker, the plant can be selfed to create a true breeding line with the same genome or it can be introgressed into one or more lines of interest. The term “introgression” refers to the transmission of a desired allele of a genetic locus from one genetic background to another. For example, introgression of a desired allele at a specified locus can be transmitted to at least one progeny via a sexual cross between two parents of the same species, where at least one of the parents has the desired allele in its genome. Alternatively, for example, transmission of an allele can occur by recombination between two donor genomes, e.g., in a fused protoplast, where at least one of the donor protoplasts has the desired allele in its genome. The desired allele can be, e.g., a selected allele of a marker, a QTL, a transgene, or the like. In any case, offspring comprising the desired allele can be repeatedly backcrossed to a line having a desired genetic background and selected for the desired allele, to result in the allele becoming fixed in a selected genetic background.

The marker loci identified using the methods of the present invention can also be used to create a dense genetic map of molecular markers. A “genetic map” is a description of genetic linkage relationships among loci on one or more chromosomes (or linkage groups) within a given species, generally depicted in a diagrammatic or tabular form. “Genetic mapping” is the process of defining the linkage relationships of loci through the use of genetic markers, populations segregating for the markers, and standard genetic principles of recombination frequency. A “genetic map location” is a location on a genetic map relative to surrounding genetic markers on the same linkage group where a specified marker can be found within a given species. In contrast, a physical map of the genome refers to absolute distances (for example, measured in base pairs or isolated and overlapping contiguous genetic fragments, e.g., contigs). A physical map of the genome does not take into account the genetic behavior (e.g., recombination frequencies) between different points on the physical map.

In certain applications it is advantageous to make or clone large nucleic acids to identify nucleic acids more distantly linked to a given marker, or isolate nucleic acids linked to or responsible for QTLs as identified herein. It will be appreciated that a nucleic acid genetically linked to a polymorphic nucleotide sequence optionally resides up to about 50 centimorgans from the polymorphic nucleic acid, although the precise distance will vary depending on the cross-over frequency of the particular chromosomal region. Typical distances from a polymorphic nucleotide are in the range of 1-50 centimorgans, for example, often less than 1 centimorgan, less than about 1-5 centimorgans, about 1-5, 1, 5, 10, 15, 20, 25, 30, 35, 40, 45 or 50 centimorgans, etc.

Many methods of making large recombinant RNA and DNA nucleic acids, including recombinant plasmids, recombinant lambda phage, cosmids, yeast artificial chromosomes (YACs), PI artificial chromosomes, Bacterial Artificial Chromosomes (BACs), and the like are known. A general introduction to YACs, BACs, PACs and MACs as artificial chromosomes is described in Monaco & Larin, Trends Biotechnol. 12:280-286 (1994). Examples of appropriate cloning techniques for making large nucleic acids, and instructions sufficient to direct persons of skill through many cloning exercises are also found, for example, in Sambrook et al., (1989) Molecular Cloning: A Laboratory Manual, Cold Spring Harbor Laboratory, Cold Spring Harbor.

In addition, any of the cloning or amplification strategies described herein are useful for creating contigs of overlapping clones, thereby providing overlapping nucleic acids which show the physical relationship at the molecular level for genetically linked nucleic acids. A common example of this strategy is found in whole organism sequencing projects, in which overlapping clones are sequenced to provide the entire sequence of a chromosome. In this procedure, a library of the organism's cDNA or genomic DNA is made according to standard procedures described, e.g., in the references above. Individual clones are isolated and sequenced, and overlapping sequence information is ordered to provide the sequence of the organism.

Once one or more QTLs have been identified that are significantly associated with the expression of the gene of interest, then each of these loci and linked markers may also be further characterized to determine the gene or genes involved with the expression of the gene of interest, for example, using map-based cloning methods as would be known to one of skill in the art. For example one or more known regulatory genes can be mapped to determine if the genetic location of these genes coincide with the QTLs controlling mRNA expression of the gene of interest. Confirmation that such a coinciding regulatory gene is effecting the expression of one or more genes of interest can be obtained using standard techniques in the art, for example, but not limited to, genetic transformation, gene complementation or gene knock-out techniques, or overexpression. The genetic linkage map can also be used to isolate the regulatory gene, including any novel regulatory genes, via map-based cloning approaches that are known within the art whereby the markers positioned at the QTL are used to walk to the gene of interest using contigs of large insert genomic clones. Positional cloning is one such a method that may be used to isolate one or more regulatory genes as described in Martin et al. (Martin et al., 1993, Science 262: 1432-1436; which is incorporated herein by reference). “Positional gene cloning” uses the proximity of a genetic marker to physically define a cloned chromosomal fragment that is linked to a QTL identified using the statistical methods herein. Clones of linked nucleic acids have a variety of uses, including as genetic markers for identification of linked QTLs in subsequent marker assisted breeding protocols, and to improve desired properties in recombinant plants where expression of the cloned sequences in a transgenic plant affects an identified trait. Common linked sequences which are desirably cloned include open reading frames, e.g., encoding nucleic acids or proteins which provide a molecular basis for an observed QTL. If markers are proximal to the open reading frame, they may hybridize to a given DNA clone, thereby identifying a clone on which the open reading frame is located. If flanking markers are more distant, a fragment containing the open reading frame may be identified by constructing a contig of overlapping clones. However, other suitable methods may also be used as recognized by one of skill in the art. Again, confirmation that such a coinciding regulatory gene is effecting the expression of one or more genes of interest can be obtained via genetic transformation and complementation or via knock-out techniques described below.

Upon identification of one or more genes responsible for or contributing to a trait of interest, transgenic plants can be generated to achieve the desired trait. Plants exhibiting the trait of interest can be incorporated into plant lines through breeding or through common genetic engineering technologies. Breeding approaches and techniques are known in the art. See, for example, Welsh J. R., Fundamentals of Plant Genetics and Breeding, John Wiley & Sons, NY (1981); Crop Breeding, Wood D. R. (Ed.) American Society of Agronomy Madison, Wis. (1983); Mayo O., The Theory of Plant Breeding, Second Edition, Clarendon Press, Oxford (1987); Singh, D. P., Breeding for Resistance to Diseases and Insect Pests, Springer-Verlag, NY (1986); and Wricke and Weber, Quantitative Genetics and Selection Plant Breeding, Walter de Gruyter and Co., Berlin (1986). The relevant techniques include but are not limited to hybridization, inbreeding, backcross breeding, multi-line breeding, dihaploid inbreeding, variety blend, interspecific hybridization, aneuploid techniques, etc.

In some embodiments, it may be necessary to genetically modify plants to obtain a trait of interest using routine methods of plant engineering. In this example, one or more nucleic acid sequences associated with the trait of interest can be introduced into the plant. The plants can be homozygous or heterozygous for the nucleic acid sequence(s). Expression of this sequence (either transcription and/or translation) results in a plant exhibiting the trait of interest. Methods for plant transformation are well known in the art.

The following examples are offered by way of illustration and not by way of limitation.

### EXPERIMENTAL EXAMPLES

### Example 1

### Location Selection for Drought Status

### Analysis Methods

Weather information collected during the growing season was interpolated to growing locations. A crop model was used to synchronize weather conditions with corn developmental stages. This task was carried out by the “Key model” tool. This model was developed to extrapolate weather information and related conditions from information collected at sites distant from the actual planting sites. The relevant information may be extrapolated using, for example, historical data for that location. The water balances provided by this tool were used to define the drought status for the seedling (SD), vegetative (VG), flowering (FL), and grain filling (GF) developmental stages.

The water balances were standardized into z values using MS Excel. According to the z value for a drought condition in certain stage, 4 groups were created, assuming that water balances will have a normal distribution. Drought conditions “A” were defined by z values greater than 1; drought conditions “B” will have z values between 1 and −1; drought conditions “C” were defined by z values smaller than −1; and drought conditions “D” were defined by z values smaller than −1.65. Experiments with trials under drought conditions and comparable trials under optimal conditions were selected and then the corresponding entries were identified.

### Results

A total of 144 locations were identified where all the stage 2 and 3 experiments were grown. However, 102 locations were non-irrigated and thus used for this analysis. Locations not reported or without coordinates were not included.

### Water Balance Estimation

The Key Model tool was used to estimate the soil water balance. In order to run the Key Model, it was necessary to obtain the Location ID, location coordinates, maturity group, the soil water capacity and planting date. The soil water capacity at each non irrigated location was estimated using ARC GIS 9.2. Some of these variables were missing for some of the locations e.g. USHE, USAO, and USJA stations. So, historical information on these locations was used, and, when this information wasn't available, the information available on the nearest possible location was used.

In addition, the model included information on soil available water capacity (AWC) for the first 150 cm of soil profile. The AWC depends on soil profile attributes such as soil texture, soil structure and soil organic matter. Crop water balances can be significantly affected by AWC. For instance, two different locations with the same precipitation and the same atmospheric water demand can vary greatly in water balance if they differ in AWC. If one location has a very sandy soil profile with low AWC, it becomes water stressed sooner than the location with less sand in the soil profile. The AWC for the first 150 cm of soil profile is available at the NRCS STATGO soil database at geostac.tamu.edu. The Key Model was modified and run assuming that the soil profile was at field capacity at planting using the new AWC information.

The Key model estimated the water balance for each location at the seedling, vegetative, flowering and grain filling developmental stages.

### Location Selection Based on the Water Balance

The criteria of selecting locations based on water balances is different from the initially proposed (refer to Analysis Methods). The initial proposed model is a parametric method based on mean and standard deviation estimations. It assumes that the distribution of water balances is normal. Nevertheless, the observed water balances have non-normal distributions since they are skewed to the lower values and are leptokurtic. Thus the mean is smaller than the median. This shift impacts in the effectiveness of the procedure to classify locations and the number of locations under drought can be underestimated.

To overcome this issue, a non-parametric approach based on deciles was used. This procedure does not require the estimation of means and standard deviations. It is based on the actual frequency of water balances. Similar approaches have been used to define drought conditions in Australia (Gibbs and Maher, 1967). In this case, the most negative water balances in the first 15^{th} percentiles, for the flowering or grain filling stages were classified as “severe drought”. Similarly, locations of negative balances for these stages between the 15^{th} and the 30^{th} percentiles were classified as locations with “moderate drought.”

The analysis indicated that there were 16 locations with water balances that were in the lowest 15^{th} percentiles for either the flowering or the grain filling developmental stages.

### Verification of Selected Locations

These severe stress locations were confirmed using drought indices. The Modified Palmer Severity Index (MPDSI) takes into account previous soil conditions and presents long-term fluctuations. In contrast, the Moisture Anomaly Index (MAI) focuses on precipitation anomalies and presents short term fluctuations. Both indices were estimated by the National Climatic Data Center (NCDC) under NOAA. Moreover, locations were validated with 2006 drought maps produced by the National Drought Mitigation Center (NDMC).

This location list was further verified by the field Station Managers and as a result:

There were locations initially considered under mild stress that were updated as severe stress.

There were locations initially considered as severe stress locations that were not confirmed. Hence they were excluded.

Given the water balance analysis, the drought indices, and the Station Manager feedback, 14 locations were used for the analysis.

### Experiment, Trial and Entry Identification

There were stage 2 trials in 9 locations and Stage 3 trials in 12 locations. There were 296 Stage 3 experiments with 476 trials.

### Conclusions

The drought status of locations was evaluated across the growing season to develop a drought description. Locations with the desired drought severity at the most significant moments of the season were selected. Entries present in these locations were identified to verify associations between candidate genes and yield under drought conditions in elite breeding material using existing stage 2 & 3 yield data. The analysis identified 14 locations, 440 experiments and 14059 entries.

### REFERENCES

W J Gibbs, J V Maher. Rainfall deciles as drought indicators. Bureau of Meteorology Bulletin No. 48, Commonwealth of Australia, Melbourne, 1967.

### Example 2

### Steps for Association Mapping Using Trait-Based Selection of Principal Components as Covariates of Linear Models

1a) Obtain phenotypic data from designed field experiment
OR
1b) Obtain opportunistic phenotypic data from breeding trials
2) Quality control of phenotypic data. Avoid locations with high percentage of missing data (e.g. missing data >20%). Remove outliers.
3) Phenotypic adjustments by linear models. If hybrid data, the effect of tester should be considered in the models. If multiple locations of inbred or hybrid data, the effect of the locations should be considered in the models, or different locations should be analyzed separately. Having repetitions is desirable to increase the accuracy of the estimation of the effect and variance component of entries.
4) Preparation of phenotypic input file. The phenotypic input file should contain the estimate of the effect of the entries for each trait to be analyzed (e.g. Least square means or Best Linear Unbiased Predictors BLUPs).
5) Procurement of seed of the inbred entries or parental inbreds for hybrids to be planted in the greenhouse for germination and tissue sampling.
6) DNA extraction.
7) Selection of genotyping platform and molecular markers. Different options include, for example, fluorescence probe-based genotyping of candidate SNP assays, bead-based SNP arrays, high throughput resequencing, etc.
8) Quality control of genotypic data. Markers with high percentage of missing data (e.g. missing data >15%) should be removed or repeated.
9) Preparation of genotypic data input file. Each inbred entry should have a value for each molecular marker screened (e.g. A, T, C or G for SNP markers). Heterozygous data should be treated as missing data.
10) Preparation of the annotation file. The minimum components of the association file are a name for the marker, the chromosome in which it resides and a position in the consensus genetic or physical map. Additional information can be whether the marker resides in coding region, function of the gene, metabolic pathways, etc.
11) Principal component analysis for the markers. A sample of all the genotypic markers available for the inbred entries (e.g. ˜1000 SNP markers) should be extracted from the genotypic input file and formatted for use in a desired statistical analysis program. The map information for the markers should be extracted from the annotation file. The output files will include a matrix with the eigenvectors for the desired number of Eigenvalues or principal components for each of the inbred entries. This file is referred as the PCA file.
12) Using the inbred entries name, the phenotypic input file and the PCA file should be merged into a single file in which each entry (row) must have a series of columns some of which will be the phenotypes or traits and the rest will be the Eigenvectors. This merged file must be formatted to be read for statistical software capable of analyze mixed linear models, analysis of variance, and/or Pearson's correlations (e.g. R, JMP, SAS, SPSS, S-Plus, etc.)
13) Trait-based selection of principal components. Each phenotype or trait should be analyzed separately. The objective of this analysis is to identify which of all the principal components or Eigenvalues are significantly associated with the trait.
13a) Calculate Pearson's pairwise correlations for each trait with each principal component. Test for significance of the correlations coefficients and identify the significant p-values (e.g. p-values <0.05).
13b) Run analysis of variance testing for each principal component as a source of variation for the variance observed in the trait of phenotype. Identify the significant p-values of the F tests (e.g. p-values <0.05).
13c) Run a linear model for each trait. The trait will be the dependent variable and the principal components are predictor variables. The predictors can be incorporated in the model as fixed or random effects. If considered random the model becomes a mixed linear model. Identify the significant p-values of the tests for each predictor variable (e.g. p-values <0.05).
14) Remove the non-significant principal components or Eigenvalues from the PCA file. This file is now referred as the selected PCA input file.
15) Estimate the kinship coefficient or additive relationship matrix. There are some analytical options available such as SPAGeDi and TASSEL. A sample of all the genotypic markers available for the inbred entries (e.g. ˜1000 SNP markers) should be extracted from the genotypic input file. This file should be formatted to be read by SPAGeDi or TASSEL. The output file is a square matrix with the kinship coefficients. This file will be referred as the kinship matrix file.
16) Select software for association mapping or Linkage disequilibrium analysis. There are several options for the association mapping analysis such as TASSEL, R, HelixTree, SAS, ASREML, MTDFREML. TASSEL is publicly available software and one of the most popular ones for association mapping in plants.
17) The phenotypic input file, the genotypic data input file, the selected PCA file, and the kinship matrix files should be formatted to be read by TASSEL.
18) Once the files are in TASSEL, the analysis is initiated by running a general linear model in which the phenotype or trait is the dependent variable, the molecular markers (e.g. SNPs) are a predictor fixed variable, and the selected principal components or Eigenvalues are cofactors to adjust for population structure. TASSEL can be asked to calculate an experiment-wise p-value for each marker that correct the F test p-value to avoid false positives due to multiple testing. A threshold experiment-wise p-value is decided upon (e.g. experiment-wise p-value <0.05) to identify significant marker trait associations.
19) In addition to the linear model, a posterior analysis is done considering the phenotype or trait as the dependent variable, the molecular markers (e.g. SNPs) as predictor fixed variables, the selected principal components or Eigenvalues as cofactors to adjust for population structure, and the kinship matrix or additive relationship matrix as a component of a random term that helps to further refine the population structure relationships of the inbred entries. Because of the incorporation of random terms in the model, this becomes a mixed linear model. The p-values for each marker can be corrected to avoid false positives due to multiple testing using Bonferroni correction of p-values. A threshold for the corrected p-values is defined and the significant marker trait associations are identified.

### Example 3

### Association Mapping for Traits Related to Ethanol Production in Corn

### Background

Marker-assisted selection (MAS) has become a common practice in breeding. The efficiency of MAS, however, depends on the accuracy in detection of markers closely linked to QTLs. Association mapping has been widely used as an alternative to linkage mapping in detecting QTLs. This approach is based on linkage disequilibrium (LD) between linked loci. Because LD usually exists only in much narrower chromosomal regions, QTLs can be mapped at much higher resolution than linkage mapping. However, LD can occur between unlinked loci, which are undesirable, and spurious LD can be caused by population structure and genotyping errors, etc. As a result, to reliably detect true LD between closed linked loci, sophisticated statistical approaches are needed to minimize false positives of various kinds. TASSEL is one of the software packages that can achieve this goal. TASSEL is based on mixed linear model with population structure and genetic correlations being explicitly controlled in the models. This package was used for association analysis with the ethanol data in this report.

### Methods and Results

### Phenotypic Data

Two sets of data with phenotypic information for inbred lines (1765 entries) were provided. The traits available for analysis were starch, protein, oil, moisture, density, dry grind standard (DGS)-24, DGS-48, and DGS-72. As expected there was a positive and significant correlation between Starch and DGS traits. There was negative correlation between Protein and Starch and DGS traits.

### Genotypic Data

### Fluorogenic Probe-Based SNPs (TaqMan®)

A total of 496 TaqMan SNPs were scored in 2052 inbred lines that were included in the association platform list. These SNPs were used for association and population structure analysis.

Bead-Based High throughput SNPs (Illumina Golden Gate )

A GoldenGate array composed of 1536 SNPs was used to genotype 485 inbred lines. After removing low quality data and non-informative SNPs, 1158 SNPs were selected for the analysis.

### Kinship Analysis

Kinship was calculated as the proportion of shared alleles. Kinship analysis was done using genotypic data of 496 Taqman SNP assays.

### PCA Analysis

Principal Component Analysis (PCA) or “Eigen value analysis” has been proposed as an alternative to Structure for inferring population structure from genotypic data (Patterson et al., 2006). PCA has some advantages over Structure such as the processing speed for large datasets and avoiding the need of selecting a specific number of sub-populations. PCA was performed using the software SMARTPCA that is part of EIGENSTRAT using data from the GoldenGate array. The first three PCs (listed according to eigen value) grouped the inbred lines in a similar way as groups based on historical heterotic groups. PCs selected among the first 50 Eigen values and their corresponding Eigenvectors for each of the lines were used as another covariate series for the association models of TASSEL.

Selection of PCs Based on Association with the Trait of Interest.

The utilization of PCs as covariates in linear model-based association mapping has relied on the assumption that the first PC's are the best covariates because they explain most of the genetic variation found with the markers (Zhao et al., 2007). However, PCs with the largest variances are not necessarily the best covariates in a model since minor PCs could be highly correlated with the trait of interest (Aguilera et al., 2006). Both GLM and MLM were used to assess the significance of each of the 50 PCs and to estimate the percentage of the variation explained by them.

The correlation between PCs and the phenotype was dependent on the trait and sometimes large PCs (i.e., PCs with higher eigen values) did not explain much of the variation, whereas minor PCs (i.e., PCs with lower eigen values) explained a considerable percentage of the variation for certain traits.

### Association Analysis Using TASSEL

The java-based software TASSEL (Trait Analysis by aSSociation, Evolution and Linkage) incorporates linear model (both general and mixed) approaches to establish association between markers and phenotypes while controlling for population and family structure (Bradbury et al., 2007). Population structure (Q) and/or Kinship (K) estimates can be incorporated in the models to reduce the number of false positives. It is also possible to replace the Q (Structure) matrix by a PCA matrix (Eigen values) (Price et al., 2006; Zhao et al., 2007).

Association Models in TASSEL

The models used in TASSEL include:

1) General Linear Model: Phenotype=Marker+selected PCs (Eigen values); and,

2) Mixed Linear Model: Phenotype=Marker+selected PCs (Eigen values)+K (pshared)

A “selected PC” is a PC that is selected based on its correlation to the trait of interest.

### Adjustments for Multiple Testing

The GLM procedure in TASSEL includes the option to perform permutations to find out the experiment-wise error rate that corrects for accumulation of false positives when doing multiple comparisons. A total of 1,000 permutations were used. The MLM procedure does not include correction for multiple testing. The software QVALUE (Storey, 2002) was used to calculate q-values to control for the false discovery rate (FDR). The q-values are similar to p-values since they give each hypothesis test a measure of significance in terms of a certain error rate. The q-values are useful for assigning a measure of significance to each of many tests performed simultaneously.

### Association Results in Inbred Platform

Phenotypic data was available for 1732 lines that had marker information in the Taqman 496SNPs set. The use of Mixed Linear Models to detect marker: trait associations in data sets of considerable size (>1000) is limited by the computation time required to analyze the Kinship component of the model. As an alternative, the General Linear Models were refined to correct for population structure as much as possible without the need for the kinship matrix.

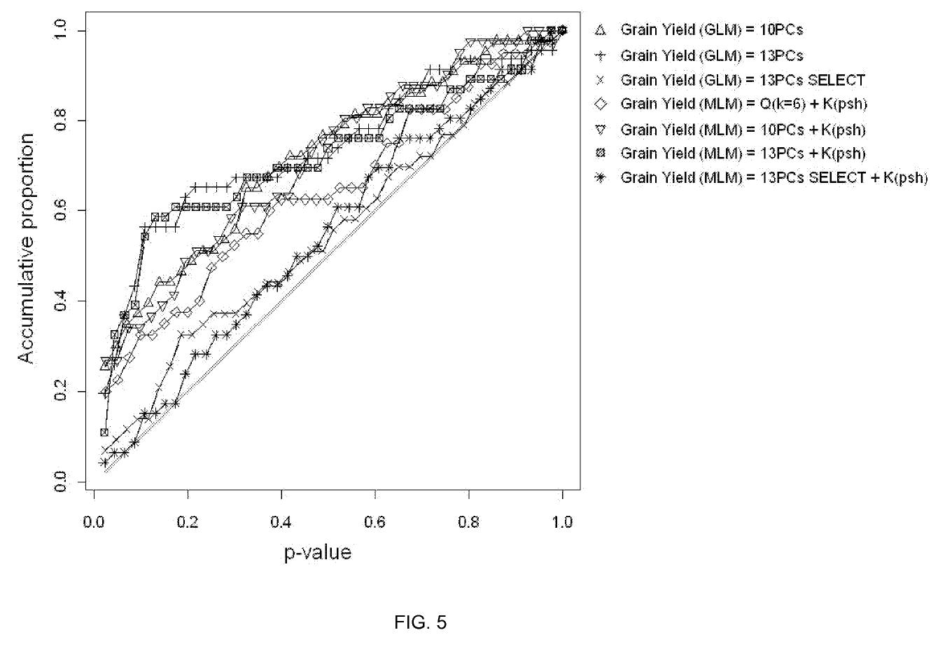

Comparison between several GL models (FIG. 5) showed that the selection of PCs based on trait significance helps to reduce the bias towards significance. The comparison also showed that if accepting the true number of subpopulations as the k with the highest log probability of the data Pr(X/K) or k=10 subpopulations, the results are skewed towards significance. A similar result was observed when using k=5 as the number of subpopulations that better correspond with the expected number of historical heterotic groups.

The selection of the significant PCs as covariates in the linear models helped to control the distribution of p-values (i.e. avoid large numbers of false positives). However, variation was observed between the different traits.

A total of 85 SNPs showed experiment-wise p-value p<0.05 in the GLM using significantly-associated PCs as covariates. The traits with the most significant marker trait associations (MTAs) were oil and protein with 13 and the one with least significant association was moisture with seven. A total of 15 SNPs out of the 85 with significant p-values (experiment-wise p-value <5%) showed association with more than one trait.

### Association Results in Inbred Panel.

Phenotypic data was available for 576 inbred lines that had genotypic information from 1654 SNPs. In addition to a larger number of SNP data, the reduced size of the inbred panel in comparison to the inbred platform allows a reduction in the running time of the Mixed Linear Models.

The selection of the significant PCs as covariates in the linear models helped to control the distribution of p-values (i.e. avoid large numbers of false positives) The inclusion of the kinship matrix as the additive relationship matrix in the mixed model helped to reduce the false positive rate to expected levels and to increase the R² of the models

The SNPs showing the most significant p-values are consistent in the GL and ML models. A total of 122 SNPs showed experiment-wise p-value p<0.05 in the GLM. All 122 SNPs showed individual p-values of p<0.05 in the MLM. This indicates that even after the inclusion of the kinship matrix to control for additional genetic relatedness among the inbred lines, the marker: trait associations remain significant. The trait with most significant marker trait associations (MTAs) was oil with 24 and the one with least was protein with 10.

A total of nine SNPs out of the 122 with significant p-values (experiment-wise p-value <5%) showed association with more than one trait. When comparing the results between the inbred panel and the inbred platform for the 496 TaqMan SNPs, ten (10) loci showed experiment-wise p-value p<0.05 in both data sets.

### REFERENCES

Aguilera, A. M., M. Escabias, and M. J. Valderrama. 2006. Using principal components for estimating logistic regression with high-dimensional multicollinear data. Computational Statistics & Data Analysis 50:1905-1924.
Bradbury, P. J., Z. Zhang, D. E. Kroon, T. M. Casstevens, Y. Ram-doss, and E. S. Buckler. 2007. TASSEL: Software for Association Mapping of Complex Traits in Diverse Samples, pp. btm308.
Loiselle, B. A., V. L. Sork, J. Nason, and C. Graham. 1995. Spatial genetic structure of a tropical understory shrub, Psychotria officinalis (Rubiaceae). American Journal of Botany 82:1420-1425.
Patterson, N., A. L. Price, and D. Reich. 2006. Population Structure and Eigenanalysis. PLoS Genetics 2:e190.
Price, A. L., N. J. Patterson, R. M. Plenge, M. E. Weinblatt, N. A. Shadick, and D. Reich. 2006. Principal components analysis corrects for stratification in genome-wide association studies. Nat Genet 38:904-909.
Ritland, K. 1996. Estimators for pairwise relatedness and individual inbreeding coefficients. Genet. Res. 67:175-186.
Storey, J. D. 2002. A direct approach to false discovery rates. Journal of the Royal Statistical Society: Series B 64:479-498.
Yu, J., Z. Zhang, D. A. Abanao, G. Pressoir, T. M. R., S. Kresovich, R. J. Todhunter, and E. S. Buckler. 2007. Relatedness estimation with different numbers of background markers and association mapping with different sample sizes. Theor Appl Genet In press.
Zhao, K., M.a.J. Aranzana, S. Kim, C. Lister, C. Shindo, C. Tang, C. Toomajian, H. Zheng, C. Dean, P. Marjoram, and M. Nordborg. 2007. An Arabidopsis Example of Association Mapping in Structured Samples. PLoS Genetics 3:e4.
Zheng, C. Dean, P. Marjoram, and M. Nordborg. 2007. An Arabidopsis Example of Association Mapping in Structured Samples. PLoS Genetics 3:e4.

### Example 4

### Validation of Yield Candidate Genes by Association Mapping with 2005 Stage 2 Data

### Objectives

This approach to increase corn yield involves the identification and use of native variation in candidate genes or loci that associate with yield and yield components. Identification and validation of genes associated with yield are critical to the success and high efficiency of downstream marker-assisted breeding. The objective of this experiment was to validate the genetic effects of a selected set of yield candidate genes based on their molecular functions and phenotypic effects in other species homologous to corn with corn breeding stages 2-3 data.

### Background

Genetic variability is the main requirement to obtain genetic gain. Identifying genetic variability in elite germplasm is more difficult than in wider genetic pools (i.e. exotic germplasm), but it is an adequate approach to retain the elite character of the breeding germplasm (i.e. maintain higher means) and to maintain the identity of the heterotic groups (Rasmusson and Phillips, 1997; Yu and Bernardo, 2004). Thus, genetic variations identified from elite germplasm would be much easier to be introduced in our new products. A group of candidate genes has been identified. These genes theoretically have molecular functions related to yield and yield components and/or exhibited such phenotypic effects in other species. However, the actual effects of these genes in corn, and whether they are associated with corn economic traits, are unknown.

The validation attempted here is 1) to assess the genetic associations of these candidate genes with the traits evaluated in high yielding conditions; 2) to demonstrate the existence of different allelic effects for the candidate genes in the core of elite germplasm that have a significant effect in the traits.

Phenotypic data

The breeders evaluate corn hybrids at different stages of the breeding process in multiple locations to assess yield and other agronomic characters. Phenotypic data has been collected on the materials used in this experiment. In this analysis, three traits were evaluated: yield (grain yield at standard moisture %), moisture (grain moisture at harvest), and weight (grain weight per plot).

### Assessment of the Phenotypic Data

The mean values of the phenotypic data of hybrids of the lines across locations and testers for yield, moisture and weight were 201.68 bushels/acre, 18.95% and 25.29 bushels/plot, respectively. The phenotypic data for the selected trials included information from 69 locations during the growing season. The number of observations in these locations ranged from 1 to 725. A total of 890 inbreds were evaluated in crosses with 33 different inbred testers. The number of observations for inbred lines crossed to a particular tester ranged from 4 to 2167 across all locations. An empirical threshold of a minimum of 300 observations was set to select 10 subsets of lines with each subset crossed to a particular tester and 10 subsets of lines with each subset evaluated in a particular location.

### Phenotypic Adjustments

To obtain a unique trait value for each inbred line that could be compared against its genotype, it was necessary to make phenotypic adjustments that help to control the effect of tester and/or location. Additional factors (e.g. maturity group) were not considered to avoid the further reduction of degrees of freedom or subsets sample sizes.

To do the phenotypic adjustments, mixed linear model analysis was performed in two different statistical packages, SAS/JMP and R, which was intended to make sure the mixed-model approaches for the large data set were implemented correctly. Since both pieces of software gave very close results, the SAS/JMP results were used for the downstream data analysis. The “full model” analysis included effects of both locations and testers in the model as follows:

Phenotype=Location effect (random)+Line effect (random)+Tester effect (fixed)+error term

The “by Location” model was used for each of the 10 selected locations as follows:

Phenotype=Line effect (random)+Tester effect (fixed)+error term

The “by Tester” model was used for each of the 10 selected subsets of lines crossed to a particular tester as follows:

Phenotype=Location effect (random)+Line effect (random)+error term

The 21 models per trait (1 full model, 10 by-location models and 10 by-tester models) were evaluated for convergence, estimation of covariance estimates, significance of fixed effects, etc. BLUPs for line effects were used as adjusted genotypes. In some cases, the proposed mixed models did not converge or there was a problem with the estimation of line effects due to the lack of replications. For those cases the effect of the lines was removed from the model and the residuals were used as a rough method to capture line effects (additional replication is obtained later in the association analysis where each bi-allelic locus is represented by the total number of inbred lines of each group).

### Adjusted Phenotypes

The solution for the lines random effects (Best Linear Unbiased Prediction, BLUPs) were obtained from the mixed models that converged. For those models that did not converge the residuals were obtained.

### Genotypic Data

A total of 890 lines for which phenotypic data was collected in any of the selected trials were also genotyped. A total of 61 SNPs corresponding to 17 candidate genes were scored in the inbred lines. After eliminating monomorphic assays and SNPs with allele frequencies less than 0.01, 46 candidate SNPs were tested for association in TASSEL.

### Methodologies for Association Analysis

Association mapping (often referred as linkage disequilibrium mapping) has become a powerful tool to unveil the genetic control of complex traits. Association mapping relies on the large number of generations, and therefore recombination opportunities, in the history of a species, that allow the removal of association between a QTL and any marker not tightly linked to it (Jannink and Jansen (2001) Genetics 157(1):445-54). One of the most important steps in association mapping analysis is the control for population structure that can cause spurious correlations between markers and phenotypes and thus increased false-positive rate.

a) Kinship Analysis

The method implemented in TASSEL uses a kinship matrix in the mixed-model approach for controlling genetic correlations among lines. Kinship analysis was done using genotypic data on the 299 random SNP assays. Kinship coefficients were defined as the proportion of shared alleles for each pair of individuals (K pShared). Zhao et al. used the proportion of shared haplotypes as their kinship coefficients. The matrix of K coefficients was included for some association models in TASSEL to assess the control for spurious associations due to close interrelatedness of the lines in the panel.

b) Population Structure Analysis

Structure analysis was done using genotypic data of the 299 random SNP assays. Simulations were performed using the software STRUCTURE. The linkage model, incorporating population admixture and linkage between the markers, was used. The likelihoods of population structures ranging from k=1 to 15 subpopulations were determined using a burnin period of 50000 followed 50000 MCMC reps. Four replications were run for each value of k. The estimated log probability of data Pr(X|K) for each value of k was plotted to choose an appropriate number of subpopulations to include in the covariance matrix. The probability for a determinate k increased along with the number of k tested until it reached k=6 and then started to decrease. At this point it was agreed to use k=6 as the number of sub-populations for association analysis. The inferred ancestry table containing the fraction of each subpopulation contributing to the ancestry of each inbred was used as a series of covariates in the association testing model.

c) Principal Component Analysis

Principal Component Analysis (PCA) or “Eigen analysis” has been proposed as an alternative to STRUCTURE for inferring population structure from genotypic data. PCA has some advantages over STRUCTURE such as the ability to handle large datasets in much shorter periods of time, and avoiding the need of selecting a specific number of subpopulations. PCA was performed using the software SMARTPCA that is part of EIGENSTRAT. Ten Eigenvectors and their corresponding Eigen values for each of the lines were used as another covariate series for the association models of TASSEL.

### TASSEL

The java-based software TASSEL (Trait Analysis by aSSociation, Evolution and Linkage) incorporated linear models (both general and mixed) approaches to establish association between markers and phenotypes while controlling for population and family structure (Bradbury et al., 2007). Population structure (Q) and/or Kinship (K) estimates can be incorporated in the models to reduce the number of false positives. It is also possible to replace the Q (STRUCTURE) matrix by a PCA matrix (Eigen values) (Price et al., 2006; Zhao et al., 2007).

### Association Models in TASSEL

Different general lineal (GLM) and mixed lineal (MLM) models can be implemented in TASSEL. For the yield and moisture phenotypes adjusted across locations and testers six models were run and compared (no analysis was done in TASSEL for GWTPN). For all the subsets by location and by tester a unique model was used:

Adj. Phenotype=Marker+K(pshared)*

The GLM procedure in TASSEL includes the option to perform permutations to find out the experiment-wise error rate that corrects for accumulation of false positives when doing multiple comparisons. A total of 10,000 permutations were used for the yield data. The MLM procedure does not include correction for multiple testing. The Bonferroni correction was used a posteriori to avoid accumulation of false positive.

### Results—Association Models TASSEL

### Yield Full Model

Several GL and ML models were applied to assess association of yield with candidate SNP assays. One SNP marker showed association with yield that was both significant after Bonferroni correction (correcting α=5%) in the three ML models and significant with experiment-wise p-value <0.05 in the three GL models. With the same criteria three SNPs showed significance in four of the six models, two in two models, and seven in only one model.

### Yield by Locations

The “by location” model was also used to assess association of yield with candidate SNP assays. This model to adjust yield did not converge for the data from location 4400 and the residuals were used as a rough method to capture line effects. Four SNP assays showed significant association with yield in two locations after Bonferroni correction (correcting α=5%) in the ML model. Nine more SNP assays showed significance in only one of the locations.

### Yield by Testers

The “by tester” model was also used to assess association of yield with candidate SNP assays. Two SNP assays showed significant association with yield in two testers after Bonferroni correction (correcting α=5%) in the ML model. A total of 14 more SNP assays showed significance in only one of the testers.

### Moisture Full Model

BLUPs for the line effects of GMSTP were tested to assess association in several GL and ML models with candidate SNP assays. Three SNP markers showed association with moisture that was both significant after Bonferroni correction (correcting α=5%) in two of the three ML models and significant with experiment-wise p-value <0.05 in the three GL models. With the same criteria, one SNP showed significance in four of the six models, three in three models, five in two models, three in only one model.

### Moisture by Locations

The “by location” model was also used to assess association of moisture with candidate SNP assays. Two SNP assays showed significant association with moisture in two locations after Bonferroni correction (correcting α=5%) of the ML model. A total of 15 more SNP assays showed significance in only one of the locations.

### Moisture by Testers

The “by tester” model was also used to assess association of GMSTP with candidate SNP assays. One SNP assays showed significant association with moisture in three testers after Bonferroni correction (correcting α=5%) of the ML model. Other four SNP assays showed significance in two of the testers, and 10 SNP assays showed significance in only one of the testers.

### QIPDT

QIPDT, acronym for Quantitative Inbred Pedigree Disequilibrium Test, was proposed for association mapping that takes advantage of inbred pedigree information, which may give higher statistical power and lower false positive rates with a better control of population structure issue (Stich et al. 2006, TAG 113:1121-1130). This is an extension of QPDT originally developed for mapping human disease genes (Zhang et al, 2001. Genetic Epidemiol 21:370-375—see reference in Stich et al 2006). One major advantage is that this method can be applied to materials from early breeding stages, and thus is cost-efficient, because phenotypic data on these materials are routinely collected for breeding purpose.

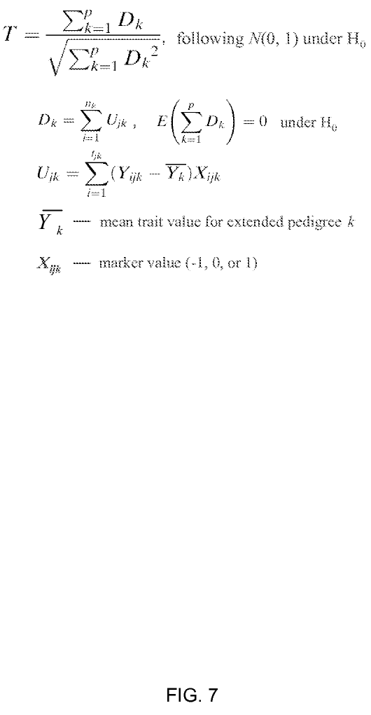

The original QIPDT is a test statistic, T, which is calculated according to FIG. 7.

For each SNP, a T value (Z was used in the QIPDT program, instead) is calculated, and its p value is found from standard normal distribution.

While the QIPDT approach is useful for testing the statistical significance of association, it does not provide an estimate of the magnitude of the SNP genetic effect, nor the relative genetic contribution to the total phenotypic variance. Thus, the approach was improved by using a regression model, which is called QIPDT2; the original method is then called QIPDT1. The model for QIPDT2 can be written as:

yᵢₖ=β₀+β₁xᵢₖ+e_{jk,}

Where yₖᵢ is adjusted phenotypic value for individual i in pedigree k; xₖᵢ is coded marker genotypic value; β₀ is intercept; β₁ is regression coefficient, or genetic effect, of the SNP in question. Note that the methods for adjusting phenotypic values and coding marker genotypes are the same as used by Stich et al. (2006). With this model, both the genetic effect and R² for each SNP can be estimated. It is important to note that the phenotypic data were pre-adjusted for excluding effects from testers and/or locations before being further adjusted for pedigree structure. The methods for pre-adjustment were the same as described previously for the TASSEL analysis.

### Results

Like the analysis with TASSEL, the phenotypic data were adjusted for locations and/or testers, depending on which subset was used. This resulted in one adjusted phenotypic value (either BLUP line values or model residuals) for each inbred, which contains a combination of all genetic effects for the inbred and random residual only. Before QIPDT analysis, all inbreds were grouped into different nuclear families, according to their parental lines. The use of nuclear families was expected to give better control of population structure than extended pedigrees that were used in Stich et al (2006). For QIPDT1, a z value and corresponding p value were estimated for each SNP; for QIPDT2, a t value and corresponding p value were derived from the simple regression model, along with R square, for each SNP. It appears that QIPDT2 was more powerful than QIPDT1, in terms of p values. QIPDT2 also gave estimates (R²) for relative contribution for each SNP.

Comparison of TASSEL vs. QIPDT2

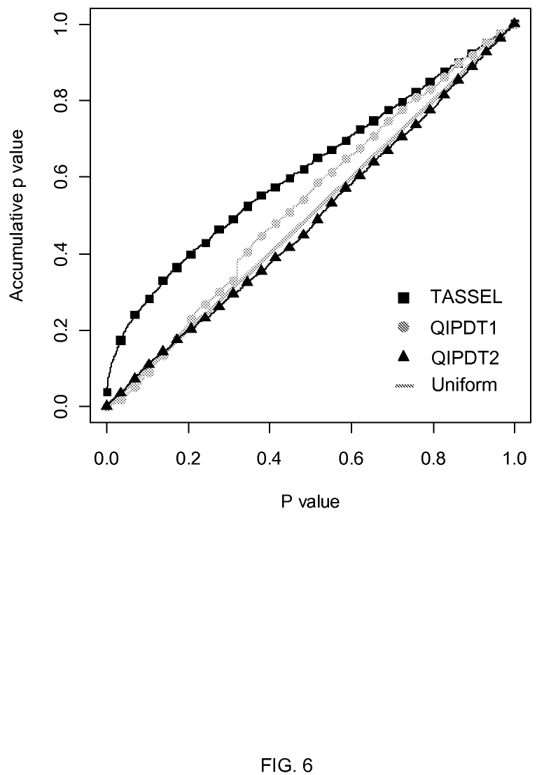

TASSEL tended to give much smaller p values than uniformly distributed p values, while QIPDT2 gave p values close to uniform p values (FIG. 6). In both methods, associations for candidate-gene SNPs were not necessarily more significant than those for non-candidate SNPs, depending on the trait of interest.

The results for association analysis using TASSEL included 30 SNP assays that were significant for moisture corresponding to 14 candidate genes and 28 SNP assays that were significant for yield corresponding to 12 candidate genes.

The results for association analysis using QIPDT2 included five SNP assays that were significant for yield corresponding to five candidate genes, nine SNP assays that were significant for moisture corresponding to nine candidate genes, and five SNP assays that were significant for weight corresponding to five genes.

### REFERENCES

Bradbury, P. J., Z. Zhang, D. E. Kroon, T. M. Casstevens, Y. Ram-doss, and E. S. Buckler. 2007. TASSEL: Software for Association Mapping of Complex Traits in Diverse Samples, pp. btm308.
Camus-Kulandaivelu, L., J.-B. Veyrieras, B. Gouesnard, A. Charcosset, and D. Manicacci. 2007. Evaluating the Reliability of Structure Outputs in Case of Relatedness between Individuals, pp. 887-890, Vol. 47.
Evanno, G., S. Regnaut, and J. Goudet. 2005. Detecting the number of clusters of individuals using the software structure: a simulation study, pp. 2611-2620, Vol. 14.
Falush, D., M. Stephens, and J. K. Pritchard. 2003. Inference of Population Structure Using Multilocus Genotype Data: Linked Loci and Correlated Allele Frequencies, pp. 1567-1587, Vol. 164.
Jannink, J. L., and B. Walsh, 2002 Association mapping in plant populations, pp. 59-68 in Quantitative Genetics, Genomics and Plant Breeding, edited by M. S. KANG. CAB International, New York.
Price, A. L., N. J. Patterson, R. M. Plenge, M. E. Weinblatt, N. A. Shadick, and D. Reich. 2006. Principal components analysis corrects for stratification in genome-wide association studies. Nat Genet 38:904-909.
Stich, B., A. Melchinger, H.-P. Piepho, M. Heckenberger, H. Maurer, and J. Reif. 2006. A new test for family-based association mapping with inbred lines from plant breeding programs. TAG Theoretical and Applied Genetics 113:1121-1130.
Zhao, K., M.a.J. Aranzana, S. Kim, C. Lister, C. Shindo, C. Tang, C. Toomajian, H. Zheng, C. Dean, P. Marjoram, and M. Nordborg. 2007. An Arabidopsis Example of Association Mapping in Structured Samples. PLoS Genetics 3:e4.

### Example 5

### Statistical Validation of Drought Candidate Genes by Association Mapping in Early Breeding Materials (Stage 2 Data)

### Objectives

The NT approach to developing drought-tolerant products involves the identification and use of native variation in candidate genes or loci that associate with yield under drought conditions. Identification and validation of genes associated with drought tolerance are critical to the success and high efficiency of downstream marker-assisted breeding. The objective of this experiment was to validate the genetic effects of a selected set of drought-tolerance candidate genes based on their molecular functions and phenotypic effects in other species homologous to corn with corn breeding stages 2-3 data.

### Identification of Drought Locations in 2005.

Drought locations were selected as described in Example 1.

### Phenotypic Data

The breeders grow their hybrids in different stages at multiple locations and evaluate for yield and other agronomic characters. Phenotypic data was collected on the materials used in this experiment. In this analysis, three traits were evaluated: yield (grain yield at standard moisture %), moisture (grain moisture at harvest), and weight (grain weight per plot).

### Assessment of the Phenotypic Data

The mean values of the phenotypic data of hybrids of the lines across locations and testers, for yield, moisture and weight were 165.41 bushels/acre, 18.94% and 20.0 bushels, respectively. The mean values for each location are close to each other, except by moisture in one location. The mean values for hybrids of the lines crossed to a particular tester within each location show a similar pattern. However, there was large variability due to testers within locations likely due to different combining ability.

### Classification of the Dataset: Locations and Testers

The number of observations in these locations ranged from 311 to 1456, and the number of unique lines in these locations ranged from 311 to 1454. These inbred lines were crossed to 47 different inbred testers. The number of lines crossed to a particular tester ranged from 1 to 575. An empirical threshold of a minimum of 240 observations was set to select sub-sets of lines crossed to a particular tester.

### Phenotypic Adjustments

Phenotypic adjustments were performed as described in Example 4.

### Genotypic Data

A total of 2189 lines for which phenotypic data was collected in any of the four selected locations were also genotyped. A total of 95 SNPs corresponding to approximately 57 candidate genes were scored in the inbred lines. After eliminating monomorphic assays and SNPs with allele frequencies less than 0.01, 85 SNPs were tested for association in TASSEL. Besides, 153 random SNPs were genotyped in the inbred lines.

### Methodologies for Association Analysis

Association analysis was performed as described in Example 4.

### Results

### Yield Under Drought Full Model

The full model to adjust yield did not converge and the residuals were used as a rough method to capture line effects. Several GL and ML models were applied to assess association with candidate SNP assays. Two SNP markers showed association with yield under drought that was both significant after Bonferroni correction (correcting α=5%) in the three ML models and significant with experiment-wise p-value <0.05 in the three GL models. With the same criteria four SNPs showed significance in four of the six models, two in three models, three in two models and 10 in only one model.

### Yield Under Drought by Locations

The “by location” model to adjust yield did not converge for the data from locations 6002 and 7346 and the residuals were used as a rough method to capture line effects. A total of 15 SNP assays showed significant association with yield under drought in one location after Bonferroni correction (correcting α=5%) in the ML model.

### Yield Under Drought by Testers

The “by tester” model to adjust yield did not converge for the data from two and therefore residuals were used as a rough method to capture line effects. Eight SNP assays showed significant association with yield in one tester after Bonferroni correction (correcting α=5%) in the ML model.

### Moisture Under Drought Full Model

BLUPs for the line effects of moisture were tested to assess association in several GL and ML models with candidate SNP assays. Four SNP markers showed association with moisture under drought that was both significant after Bonferroni correction (correcting α=5%) in the three ML models and significant with experiment-wise p-value <0.05 in the three GL models. With the same criteria one SNP showed significance in five of the six models, four SNPs in four models, one SNP in three models, six SNPs in two models and seven in only one model.

### Moisture Under Drought by Locations

The “by location” model was also used to assess association of moisture with candidate SNP assays. The “by location” model to adjust GMSTP did not converge for the data from one location. Two SNP assays showed significant association with moisture in three locations after Bonferroni correction (correcting α=5%) of the ML model. Four more SNP assays showed significance in two of the locations. Eleven more SNP assays showed significance in only one of the locations.

### Moisture Under Drought by Testers

The “by tester” model was also used to assess association of moisture with candidate SNP assays. One SNP assay showed significant association with moisture in four testers after Bonferroni correction (correcting α=5%) of the ML model. Another SNP assay showed significance in three testers. Six more SNP assays showed significance in two testers. A total of 32 other SNP assays showed significance in only one tester.

### QIPDT and QIPDT2

QIPDT and QIPDT2 analysis was performed as described in Example 4.

### Results

Like the analysis with TASSEL, the phenotypic data were adjusted for locations and/or testers, depending on which subset was used. This resulted in one adjusted phenotypic value (either BLUP line values or model residuals) for each inbred, which contains a combination of all genetic effects for the inbred and random residual only. Before QIPDT analysis, all inbreds were grouped into different nuclear families, according to their parental lines. The use of nuclear families was expected to give better control of population structure than extended pedigrees that were used in Stich et al (2006). For QIPDT1, a z value and corresponding p value were estimated for each SNP; for QIPDT2, a t value and corresponding p value were derived from the simple regression model, along with R square, for each SNP. It appears that QIPDT2 was more powerful than QIPDT1, in terms of p values. QIPDT2 also gave estimates (R²) for relative contribution for each SNP.

Comparison of TASSEL vs. QIPDT2

TASSEL tended to give much smaller p values than uniformly distributed p values, while QIPDT2 gave p values close to uniform p values Given that the number of true associations is usually a small fraction of the all SNPs, the deviation from uniform distribution might be too much for TASSEL, while QIPDT gave more reasonable p values.

In both methods, associations for candidate-gene SNPs were not necessarily more significant than those for non-candidate SNPs, depending on the trait of interest. For YGMSN, it seems that non-candidate SNPs showed higher significances than candidate SNPs, while for GMSTP, candidate SNPs showed higher significances in general.

The results for association analysis using TASSEL included 47 SNP assays that were significant for moisture corresponding to 36 candidate genes, and 31 SNP assays that were significant for yield corresponding to 25 candidate genes.

The results for association analysis using QIPDT2 included 11 SNP assays that were significant for moisture corresponding to nine candidate genes, two SNP assays that were significant for yield corresponding to two candidate genes, and two SNP assays that were significant for weight corresponding to two candidate genes

### REFERENCES

Bradbury, P. J., Z. Zhang, D. E. Kroon, T. M. Casstevens, Y. Ram-doss, and E. S. Buckler. 2007. TASSEL: Software for Association Mapping of Complex Traits in Diverse Samples, pp. btm308.
Camus-Kulandaivelu, L., J.-B. Veyrieras, B. Gouesnard, A. Charcosset, and D. Manicacci. 2007. Evaluating the Reliability of Structure Outputs in Case of Relatedness between Individuals, pp. 887-890, Vol. 47.
Evanno, G., S. Regnaut, and J. Goudet. 2005. Detecting the number of clusters of individuals using the software structure: a simulation study, pp. 2611-2620, Vol. 14.
Falush, D., M. Stephens, and J. K. Pritchard. 2003. Inference of Population Structure Using Multilocus Genotype Data: Linked Loci and Correlated Allele Frequencies, pp. 1567-1587, Vol. 164.
Jannink, J. L., and B. Walsh, 2002 Association mapping in plant populations, pp. 59-68 in Quantitative Genetics, Genomics and Plant Breeding, edited by M. S. KANG. CAB International, New York.
Price, A. L., N. J. Patterson, R. M. Plenge, M. E. Weinblatt, N. A. Shadick, and D. Reich. 2006. Principal components analysis corrects for stratification in genome-wide association studies. Nat Genet 38:904-909.
Stich, B., A. Melchinger, H.-P. Piepho, M. Heckenberger, H. Maurer, and J. Reif 2006. A new test for family-based association mapping with inbred lines from plant breeding programs. TAG Theoretical and Applied Genetics 113:1121-1130.
Zhao, K., M.a.J. Aranzana, S. Kim, C. Lister, C. Shindo, C. Tang, C. Toomajian, H. Zheng, C. Dean, P. Marjoram, and M. Nordborg. 2007. An Arabidopsis Example of Association Mapping in Structured Samples. PLoS Genetics 3:e4.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, it will be obvious that certain changes and modifications may be practiced within the scope of the appended claims.

That which is claimed:

1. A method of identifying a genetic marker associated with a trait of interest comprising:
a) providing a genotypic value for each of a plurality of genetic markers for each plant of a population, wherein said population comprises plants exhibiting said trait of interest;
b) providing a phenotypic value for said trait of interest for each member of said population of plants;
c) determining whether one or more of said markers is associated with the trait of interest using an association model comprising a means for correcting for structure in said population, wherein said correction is performed using Principle Component Analysis, and wherein principle components are selected for use in the model based on the significance of association of the principle component to the trait of interest.

2. The method of claim 1, wherein said association model is a linear model.

3. The method of claim 2, wherein said association model is a general linear model.

4. The method of claim 2, wherein said association model is a mixed linear model.

5. The method of claim 1, wherein said means for correction for structure in said population further comprises kinship analysis.

6. The method of claim 1, wherein said population of plants consists of segregating progeny in a population of early stage breeding material.

7. The method of claim 1, wherein said population of plants consists of hybrid plants.

8. The method of claim 7, wherein said hybrid plant is the result of a cross between an inbred line and an inbred tester.

9. The method of claim 1, wherein said population comprises plants cultivated in a plurality of locations.

10. The method of claim 6, wherein said phenotypic value is line effect adjusted for location effect, tester effect, or location effect and tester effect.

11. The method of claim 1, wherein said genetic marker is a single nucleotide polymorphism (SNP).

12. A method of identifying a genetic marker associated with a trait of interest comprising:
a) providing a genotypic value for each of a plurality of genetic markers in a population of breeding materials, wherein said population comprises plants exhibiting said trait of interest;
b) providing a phenotypic value for said trait of interest for each member of said population of breeding materials;
c) determining whether one or more of said markers is associated with the trait of interest using a linear regression model having a means for estimating the magnitude of the genetic effect for each of said markers and the phenotypic contribution of said markers.

13. The method of claim 12, wherein said population of breeding materials consists of inbred plants grouped in pedigrees according to common parents.

14. The method of claim 13, wherein said regression model comprises:
yᵢₖ=β₀+β₁xᵢₖ+eⱼₖ
wherein where yᵢₖ is the deviation of the phenotypic value from the pedigree mean for individual i in pedigree k;
wherein xᵢₖ is the genotypic value for said marker;
wherein β₀ is the intercept;
wherein β₁ is the regression coefficient and also an estimate of the magnitude of the genetic effect for the marker; and,
wherein the determinant coefficient of the model (R²) provides an estimate of the phenotypic contribution of the marker.

15. The method of claim 12, wherein said population of breeding materials consists of hybrid plants resulting from crosses between one or more inbred lines and one or more tester lines.

16. The method of claim 12, wherein said population of breeding materials consists of hybrid plants cultivated in a plurality of locations.

17. The method of claim 15 or 16, wherein said phenotypic value is adjusted for one or more of location effect and tester effect.

18. The method of claim 17, wherein the phenotypic value is adjusted using the mixed linear model comprising:
yᵢⱼₖ=μ+θᵢ+τⱼ+δₖ+eᵢⱼₖ,
wherein yᵢⱼₖ is the original phenotypic observation on hybrid between inbred i and tester j at location k;
wherein the tester effect (τⱼ) is treated as fixed effect;
wherein the inbred (θᵢ) and location effects (δₖ) are treated as random;
wherein best linear unbiased prediction (BLUP) is used to predict genetic values (θᵢ) of all inbreds.

19. The method of claim 12 wherein said regression model further comprises a means for correction for structure in said population.

20. The method of claim 19, wherein said means for correction of structure comprises Principle Component Analysis.

21. The method of claim 20, wherein principle components are selected for use in the model based on the significance of association of the principle component to the trait of interest.

22. The method of claim 12, wherein said breeding materials are stage 2 or stage 3 breeding materials.

23. The method of claim 12, wherein said genetic marker is a single nucleotide polymorphism (SNP).

24. The method of claim 1, further comprising introducing into a plant an expression construct comprising a nucleic acid marker associated with said trait of interest or a nucleic acid in linkage disequilibrium with a marker associated with said trait of interest, wherein said nucleic acid is operably linked to a promoter functional in the plant into which said construct is introduced, and wherein said plant thereby exhibits the trait of interest.

25. The method of claim 1, wherein a marker associated with said trait of interest is used in marker assisted breeding of a plant comprising said marker associated with said trait of interest.

25. The method of claim 12, further comprising introducing into a plant an expression construct comprising a nucleic acid marker associated with said trait of interest or a nucleic acid in linkage disequilibrium with a marker associated with said trait of interest, wherein said nucleic acid is operably linked to a promoter functional in the plant into which said construct is introduced, and wherein said plant thereby exhibits the trait of interest.

26. The method of claim 12, wherein a marker associated with said trait of interest is used in marker assisted breeding of a plant comprising said marker associated with said trait of interest.

27. A method of selecting plants optimal for evaluating an association between a marker and a trait of interest comprising:
a) providing a population comprising plants grown under a plurality of different environmental conditions;
b) collecting data related to one or more of the environmental conditions, wherein said data is collected during two or more developmental stages of said plants;
c) assigning to each plant a score associated with the environmental condition under which said plant was grown, wherein said score is assigned for each of the two or more developmental stages;
d) selecting plants exposed to a particular range of environmental conditions at one or more developmental stages, wherein said selection is appropriate for evaluating said trait of interest.

28. The method of claim 27, wherein said trait of interest is tolerance to a stress condition, and wherein said selection is based on the environmental condition most likely to induce said stress condition and the one or more developmental stages most susceptible to said stress condition.

29. The method of claim 28, wherein said stress condition is water stress, and wherein plants selected for evaluating an association between said marker and water stress are grown under conditions having the most severe level of water stress during one or more later stages of development.

30. The method of claim 27, wherein the data related to the environmental condition is obtained using Geographic Information Systems technology.
